(19) United States
(12) Patent Application Publication
(10) Pub. No.: US 2025/0138445 A1
(43) Pub. Date: May 1, 2025

(54) ELECTROPHOTOGRAPHIC APPARATUS AND PROCESS CARTRIDGE

(71) Applicant: CANON KABUSHIKI KAISHA, Tokyo (JP)

(72) Inventors: NORIFUMI MURANAKA, Kanagawa (JP); TSUTOMU NISHIDA, Shizuoka (JP); MASASHI NISHI, Kanagawa (JP); AKIHIRO MARUYAMA, Shizuoka (JP)

(21) Appl. No.: 18/922,599

(22) Filed: Oct. 22, 2024

(30) Foreign Application Priority Data
Oct. 31, 2023 (JP) 2023-187006
Oct. 3, 2024 (JP) 2024-174050

(51) Int. Cl. G03G 9/093; G03G 5/047; G03G 5/05; G03G 5/06; G03G 5/07; G03G 21/18

(52) U.S. Cl. CPC G03G 9/09342; G03G 5/047; G03G 5/0567; G03G 5/0618; G03G 5/075; G03G 9/09314; G03G 21/1814

(57) ABSTRACT

Provided is an electrophotographic apparatus having high positive chargeability even in an electrophotographic apparatus that simultaneously uses toner containing alumina particles as an external additive and a photosensitive member containing a polyarylate resin excellent in mechanical strength. In the electrophotographic apparatus, the electrophotographic photosensitive member includes a monolayer type photosensitive layer containing a charge generating material, a hole transporting material, an electron transporting material, and a binder resin, the photosensitive layer contains a polyarylate resin having a structural unit represented by the formula (1) and a structural unit represented by the formula (2) as the binder resin, the toner is toner containing toner particles, the toner particles each contain a toner base particle and an external additive adhering to a surface of the toner base particle, and the external additive contains at least aluminum oxide particles.

### BACKGROUND OF THE INVENTION

### Field of the Invention

The present invention relates to an electrophotographic apparatus and a process cartridge.

### Description of the Related Art

In recent years, an electrophotographic apparatus having a longer service life has been demanded, and simultaneously, high image quality stability has been desired even in repeated use.

The charging stability of toner is an important factor in achieving high image quality stability. In Japanese Patent Application Laid-Open No. 2023-66052, toner using alumina particles as an external additive for a purpose of improving positive chargeability of the toner has been proposed.

Meanwhile, an organic electrophotographic photosensitive member (hereinafter sometimes simply referred to as “electrophotographic photosensitive member” or “photosensitive member”) containing an organic photoconductive material (charge generating material) is used as an electrophotographic photosensitive member to be mounted on an electrophotographic apparatus or a process cartridge.

In Japanese Patent Application Laid-Open No. 2017-49298, a photosensitive member containing a polyarylate resin excellent in mechanical strength has been proposed.

According to investigations made by the inventors of the present invention, the toner using alumina particles as an external additive has a problem for use in an electrophotographic apparatus having a long service life, because the alumina particles themselves are relatively hard and hence are liable to wear a surface of a photosensitive member. In addition, when a polyarylate resin excellent in mechanical strength is used in a surface layer of the photosensitive member in order to solve the above-mentioned problem, durability of the photosensitive member is improved, but a polyarylate resin itself is easily positively charged, with a result that positive chargeability of positively charged toner using alumina particles, in particular, may be impaired.

Thus, an object of the present invention is to provide an electrophotographic apparatus having high positive chargeability even in an electrophotographic apparatus that simultaneously uses toner containing alumina particles as an external additive and a photosensitive member containing a polyarylate resin excellent in mechanical strength.

### SUMMARY OF THE INVENTION

The above-mentioned object is achieved by the present invention to be described below. That is, according to the present invention, there is provided an electrophotographic apparatus including: an electrophotographic photosensitive member; a charging unit configured to charge a surface of the electrophotographic photosensitive member; an exposing unit configured to irradiate the charged surface of the electrophotographic photosensitive member with light to form an electrostatic latent image on the surface of the electrophotographic photosensitive member; a developing unit, which includes toner, and which is configured to develop the electrostatic latent image formed on the surface of the electrophotographic photosensitive member with the toner to form a toner image on the surface of the electrophotographic photosensitive member; and a transfer unit configured to transfer the toner image from the surface of the electrophotographic photosensitive member onto a transfer material, wherein the electrophotographic photosensitive member includes a monolayer type photosensitive layer containing a charge generating material, a hole transporting material, an electron transporting material, and a binder resin, wherein the photosensitive layer contains a polyarylate resin having a structural unit represented by the following formula (1) and a structural unit represented by the following formula (2) as the binder resin, wherein the toner is toner containing toner particles, wherein the toner particles each contain a toner base particle and an external additive adhering to a surface of the toner base particle, and wherein the external additive contains at least aluminum oxide particles.

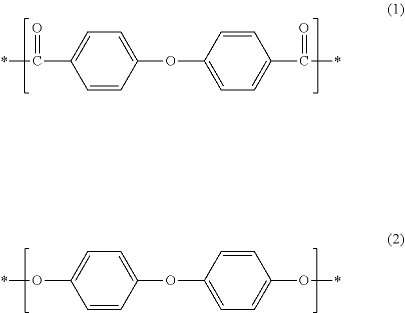

In addition, according to the present invention, there is provided a process cartridge including: an electrophotographic photosensitive member; and a developing unit, which includes toner, and which is configured to form a toner image on a surface of the electrophotographic photosensitive member with the toner, the process cartridge integrally supporting the electrophotographic photosensitive member and the developing unit, and being detachably attachable onto a main body of an electrophotographic apparatus, wherein the electrophotographic photosensitive member includes a monolayer type photosensitive layer containing a charge generating material, a hole transporting material, an electron transporting material, and a binder resin, wherein the photosensitive layer contains a polyarylate resin having a structural unit represented by the formula (1) and a structural unit represented by the formula (2) as the binder resin, wherein the toner is toner containing toner particles, wherein the toner particles each contain a toner base particle and an external additive adhering to a surface of the toner base particle, and wherein the external additive contains at least aluminum oxide particles.

Further features of the present invention will become apparent from the following description of exemplary embodiments with reference to the attached drawings.

### BRIEF DESCRIPTION OF THE DRAWINGS

FIG. 1 is a view for illustrating an example of a layer configuration of an electrophotographic photosensitive member according to the present invention.

FIG. 2 is a view for illustrating an example of a layer configuration of the electrophotographic photosensitive member according to the present invention.

FIG. 3 is a view for illustrating an example of a layer configuration of the electrophotographic photosensitive member according to the present invention.

FIG. 4 is a view for illustrating an example of a sectional structure of a toner particle in toner according to the present invention.

FIG. 5 is a view for illustrating an example of a schematic configuration of an electrophotographic apparatus including a process cartridge that includes the electrophotographic photosensitive member according to the present invention.

FIG. 6 is a view for illustrating an example of a measurement apparatus.

### DESCRIPTION OF THE EMBODIMENTS

The present invention is described below in detail by way of exemplary embodiments.

It has been found that, when a photosensitive member containing a polyarylate resin is used in a surface layer of a photosensitive member in an electrophotographic apparatus using toner containing alumina as an external additive, positive charging stability of the toner is decreased. This is presumed to be caused by a fact that a polyarylate resin used in the photosensitive member is easily positively charged to partially decrease the positive chargeability of the toner that is brought into contact with the polyarylate resin.

Based on the above-mentioned presumption, the inventors have made various investigations on a photosensitive member containing a polyarylate resin in a surface layer in an electrophotographic apparatus using toner containing alumina as an external additive, to thereby achieve the configuration of the present invention.

That is, the inventors have found the following. In an electrophotographic apparatus including toner containing alumina as an external additive and a photosensitive member using a polyarylate resin in the surface layer of the photosensitive member, when the photosensitive member includes a monolayer type photosensitive layer containing a charge generating material, a hole transporting material, an electron transporting material, and a binder resin, and the photosensitive layer contains, as the binder resin, a polyarylate resin having a structural unit represented by the following formula (1), a structural unit represented by the following formula (2), a structural unit represented by the following formula (3), and a structural unit represented by the following formula (4), a decrease in positive chargeability is suppressed, and positive charging stability can be maintained even in an electrophotographic apparatus that simultaneously uses toner containing alumina as an external additive and a photosensitive member containing a polyarylate resin in the surface layer of the photosensitive member.

The structural unit represented by the following formula (1) exhibits a structure having a high electron accepting property. In addition, when the structural unit represented by the formula (1) is bonded to the structural unit represented by the following formula (2), and the structural unit represented by formula (1) has resonance stabilization and higher electron accepting property. It is conceived that the electrophotographic photosensitive member, which contains the polyarylate resin having the structural unit represented by the following formula (1) and the structural unit represented by the following formula (2), enhances the positive chargeability of the toner when the toner is developed and transferred. That is, it is assumed that, with the incorporation of the polyarylate resin having a high electron accepting property, the electrophotographic photosensitive member can be used without impairment of the positive chargeability of the toner using alumina as an external additive.

An electrophotographic apparatus of the present invention is an electrophotographic apparatus including: an electrophotographic photosensitive member; a charging unit configured to charge a surface of the electrophotographic photosensitive member; an exposing unit configured to irradiate the charged surface of the electrophotographic photosensitive member with light to form an electrostatic latent image on the surface of the electrophotographic photosensitive member; a developing unit, which includes toner, and which is configured to develop the electrostatic latent image formed on the surface of the electrophotographic photosensitive member with the toner to form a toner image on the surface of the electrophotographic photosensitive member; and a transfer unit configured to transfer the toner image from the surface of the electrophotographic photosensitive member onto a transfer material, wherein the electrophotographic photosensitive member includes a monolayer type photosensitive layer containing a charge generating material, a hole transporting material, an electron transporting material, and a binder resin, wherein the photosensitive layer contains a polyarylate resin having a structural unit represented by the following formula (1) and a structural unit represented by the following formula (2) as the binder resin, wherein the toner is toner containing toner particles, wherein the toner particles each contain a toner base particle and an external additive adhering to a surface of the toner base particle, and wherein the external additive contains at least aluminum oxide particles.

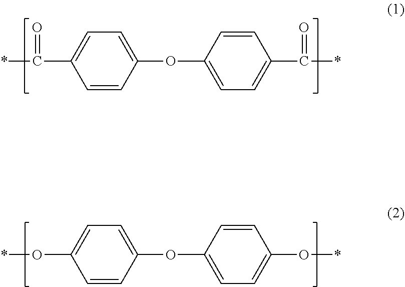

The present invention is described below.

### [Electrophotographic Photosensitive Member]

In the electrophotographic apparatus of the present invention, the electrophotographic photosensitive member includes a monolayer type photosensitive layer containing a charge generating material, a hole transporting material, an electron transporting material, and a binder resin. It is preferred that the electrophotographic photosensitive member of the present invention include at least a support and a photosensitive layer formed on the support.

A method of producing the electrophotographic photosensitive member of the present invention is, for example, a method involving: preparing coating liquids for respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

Details are described below.

### (Monolayer Type Photosensitive Member)

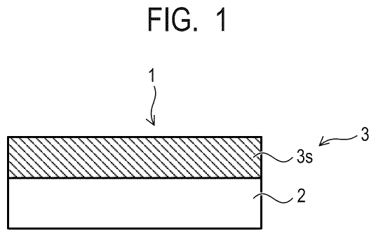

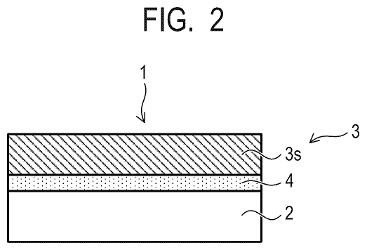

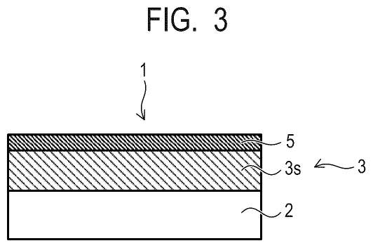

A monolayer type photosensitive member 1 that is an example of the photosensitive member of an embodiment is described below with reference to FIG. 1 to FIG. 3. FIG. 1 to FIG. 3 are each a partial sectional view for illustrating the monolayer type photosensitive member 1. As illustrated in FIG. 1, the monolayer type photosensitive member 1 includes, for example, an electroconductive base 2 and a photosensitive layer 3. The photosensitive layer 3 included in the monolayer type photosensitive member 1 is a monolayer (one layer). The one-layer photosensitive layer 3 is a monolayer type photosensitive layer 3s that is a first photosensitive layer. As illustrated in FIG. 2, the monolayer type photosensitive member 1 may further include an undercoat layer 4 (intermediate layer) in addition to the electroconductive support 2 and the monolayer type photosensitive layer 3s. The undercoat layer 4 is formed between the electroconductive base 2 and the monolayer type photosensitive layer 3s. As illustrated in FIG. 1, the monolayer type photosensitive layer 3s may be formed directly on the electroconductive support 2. Alternatively, as illustrated in FIG. 2, the monolayer type photosensitive layer 3s may be formed on the electroconductive base 2 through intermediation of the intermediate layer 4. As illustrated in FIG. 3, the monolayer type photosensitive member 1 may further include a protection layer 5 in addition to the electroconductive base 2 and the monolayer type photosensitive layer 3s. The protection layer 5 is formed on the monolayer type photosensitive layer 3s. As illustrated in each of FIG. 1 and FIG. 2, the monolayer type photosensitive layer 3s is preferably formed as an outermost surface layer of the monolayer type photosensitive member 1. When the monolayer type photosensitive layer 3s containing a polyarylate resin (PAR) to be described later is formed as the outermost surface layer, a decrease in transfer efficiency after endurance is easily suppressed. As illustrated in FIG. 3, the protection layer 5 may be formed as an outermost surface layer of the monolayer type photosensitive member 1. In the electrophotographic photosensitive member of the present invention, a thickness of the photosensitive layer (monolayer type photosensitive layer 3s) is preferably 5 μm or more and 100 μm or less, more preferably 25 μm or more and 50 μm or less. The monolayer type photosensitive layer 3s that is a first photosensitive layer contains a charge generating material, a binder resin, an electron transporting material, and a hole transporting material.

### <Support>

In the present invention, the electrophotographic photosensitive member includes a support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, a surface of the support may be subjected to, for example, electrochemical treatment such as anodization, blast treatment, or cutting treatment.

A metal, a resin, glass, etc. is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Undercoat Layer>

In the present invention, an undercoat layer may be arranged on the support. Arrangement of the undercoat layer can improve an adhesive function between layers to impart a charge injection inhibiting function.

The undercoat layer preferably contains a resin. In addition, the undercoat layer may be formed as a cured film by polymerizing a composition containing a monomer having a polymerizable functional group.

Examples of the resin include a polyester resin, a polyarylate resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting material, a metal oxide, a metal, an electroconductive polymer, etc. for a purpose of improving electric characteristics. Of those, an electron transporting material and a metal oxide are preferably used.

Examples of the electron transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting material having a polymerizable functional group may be used as the electron transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

An average thickness of the undercoat layer is preferably 0.1 μm or more and 50 μm or less, more preferably 0.2 μm or more and 40 μm or less, particularly preferably 0.3 μm or more and 30 μm or less.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Monolayer Type Photosensitive Layer>

In the present invention, the monolayer type photosensitive layer is arranged on the support, or the undercoat layer arranged on the support.

The monolayer type photosensitive layer in the present invention is formed so as to contain at least a binder resin, a charge generating material, a hole transporting material, and an electron transporting material.

### [Binder Resin]

In the electrophotographic photosensitive member of the present invention, the photosensitive layer contains, as the binder resin, a polyarylate resin having a structural unit represented by the following formula (1) and a structural unit represented by the following formula (2).

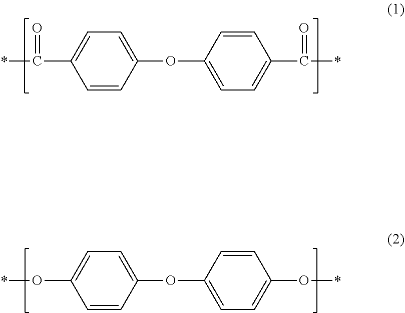

The structural unit represented by the formula (1) is a structure having a high electron accepting property. In addition, when the structural unit represented by the formula (1) is bonded to the structural unit represented by the formula (2), and the structural unit represented by formula (1) has resonance stabilization and higher electron accepting property. It is conceived that the electrophotographic photosensitive member containing the polyarylate resin having the structural unit represented by the formula (1) and the structural unit represented by the formula (2) enhances the positive chargeability of toner when the positively charged toner is developed on the electrophotographic photosensitive member and transferred onto a transfer member. It is assumed that, with this configuration, the electrophotographic photosensitive member is relatively negatively charged and the positive chargeability of the toner is relatively increased, to thereby reduce transfer residual toner.

Further, in the electrophotographic apparatus of the present invention, it is preferred that the polyarylate resin have a structural unit represented by the following formula (3) and a structural unit represented by the following formula (4) in addition to the structural unit represented by the formula (1) and the structural unit represented by the formula (2).

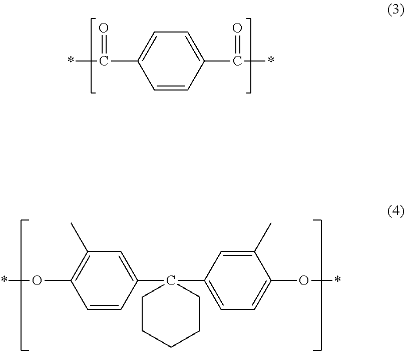

When the polyarylate resin has the structural unit represented by the formula (3) and the structural unit represented by the formula (4), solubility of the polyarylate resin in a solvent is improved, and hence a photosensitive layer can be satisfactorily formed. Each of the chemical substances of the present invention may be determined for a molecular structure thereof with a nuclear magnetic resonance (NMR) device. In the present invention, “*” in each of the formula (1) to the formula (4) represents a bonding site.

The photosensitive layer may contain a resin other than the above-mentioned polyarylate resin to an extent that the effects of the present invention are not impaired. Examples of the other resin include a polycarbonate resin, a styrene resin, and an acrylic resin. The polyarylate resin may be, for example, a random copolymer, an alternating copolymer, a periodic copolymer, or a block copolymer.

It is preferred that the polyarylate resin have the structural unit represented by the formula (1), the structural unit represented by the formula (2), the structural unit represented by the formula (3), and the structural unit represented by the formula (4), and when the molar number of the structural unit represented by the formula (1) in a total amount of molar number of the structural unit represented by the formula (1) and molar number of the structural unit represented by the formula (3) is represented by M1, molar number of the structural unit represented by the formula (2) in a total amount of molar number of the structural unit represented by the formula (2) and molar number of the structural unit represented by the formula (4) is represented by M2, molar number of the structural unit represented by the formula (3) in a total amount of molar number of the structural unit represented by the formula (1) and molar number of the structural unit represented by the formula (3) is represented by M3, and molar number of the structural unit represented by the formula (4) in a total amount of molar number of the structural unit represented by the formula (2) and molar number of the structural unit represented by the formula (4) is represented by M4, 0.30≤M3/(M1+M3)<0.7 and 0<M2/(M2+M4)<0.5 be satisfied.

M1 is preferably more than 30%, more preferably 55% or more from a viewpoint of suppressing a decrease in transfer efficiency.

M2 is preferably larger in terms of molar fraction from a viewpoint of suppressing a decrease in transfer efficiency, but is preferably less than 50% from a viewpoint of solubility in a solvent. When the solubility in a solvent is improved, a photosensitive layer can be satisfactorily formed.

M3 is preferably 35% or more and less than 70% from a viewpoint of solubility in a solvent.

M4 is preferably 80% or less from a viewpoint of suppressing a decrease in transfer efficiency, and is preferably more than 50% from a viewpoint of solubility in a solvent. Each of the chemical substances of the present invention may be determined for a molecular structure thereof by a nuclear magnetic resonance (NMR) device. Further, each of the chemical substances may be quantified by NMR or by NMR and gas chromatography mass spectrometry (CG-MS).

In the electrophotographic photosensitive member of the present invention, in the above-mentioned polyarylate resin, the sum of a ratio of a substance amount of the structural unit represented by the formula (1) and a ratio of a substance amount of the structural unit represented by the formula (3) to a total sum of substance amounts of structural units derived from dicarboxylic acids for forming the polyarylate resin is preferably 0.50 or more.

In the electrophotographic photosensitive member of the present invention, in the above-mentioned polyarylate resin, the sum of a ratio of a substance amount of the structural unit represented by the formula (2) and a ratio of a substance amount of the structural unit represented by the formula (4) to a total sum of substance amounts of structural units derived from bisphenols for forming the polyarylate resin is preferably more than 0 and 0.50 or less.

In addition, in the electrophotographic photosensitive member of the present invention, it is more preferred that the ratio of the substance amount of the structural unit represented by the formula (1) to a total of substance amounts of structural units derived from dicarboxylic acids for forming the above-mentioned polyarylate resin is 0.50 or more. Here, the substance amount is measured in moles.

Viscosity-average molecular weight of the polyarylate resin (PAR) is preferably 10,000 or more, more preferably 30,000 or more, still more preferably 50,000 or more. When the viscosity-average molecular weight of the polyarylate resin (PAR) is 10,000 or more, wear resistance of the photosensitive member is improved. Meanwhile, the viscosity-average molecular weight of the polyarylate resin (PAR) is preferably 80,000 or less, more preferably 70,000 or less. When the viscosity-average molecular weight of the polyarylate resin (PAR) is 80,000 or less, the polyarylate resin (PAR) is easily dissolved in a solvent for forming a photosensitive layer. The viscosity-average molecular weight may be determined by a known method.

Examples of bisphenols for forming bisphenol-derived repeating units (the structural unit represented by the formula (2) and the structural unit represented by the formula (4)) include a compound represented by the formula (BP-2) and a compound represented by the formula (BP-5) (the compound represented by the formula (BP-2) is hereinafter sometimes referred to as “compound (BP-2)” and the compound represented by the formula (BP-5) is hereinafter sometimes referred to as “compound (BP-5)”). Examples of the dicarboxylic acids for forming dicarboxylic acid-derived repeating units (the structural unit represented by the formula (1) and the structural unit represented by the formula (3)) include a compound represented by the formula (DC-1) and a compound represented by the formula (DC-4) (the compound represented by the formula (DC-1) is hereinafter sometimes referred to as “compound (DC-1)” and the compound represented by the formula (DC-4) is hereinafter sometimes referred to as “compound (DC-4)”). A bisphenol ratio in the resin may be adjusted by changing amounts of the compound (BP-1) and the compound (BP-2) to be added in producing the polyarylate resin (PAR). In addition, an amount of the dicarboxylic acids, that is, a dicarboxylic acid ratio in the resin may be similarly adjusted by changing amounts of the compound (DC-1) and the compound (DC-4) to be added in producing.

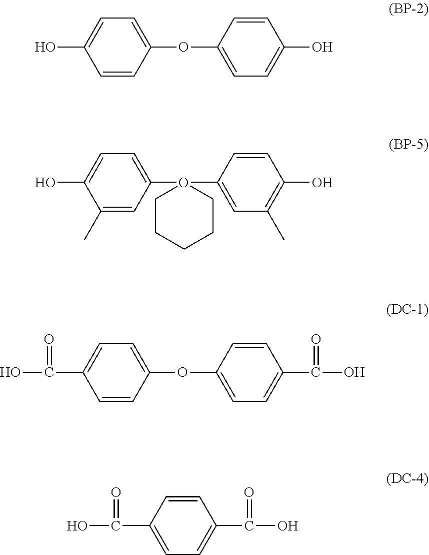

The bisphenols (e.g., the compound (BP-2) and the compound (BP-5)) may each be used by being derivatized into an aromatic diacetate. The dicarboxylic acids (e.g., the compound (DC-1) and the compound (DC-4)) may each be used by being derivatized. Examples of the derivative of the dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound obtained by substituting each of two “—C(═O)—OH” groups of the dicarboxylic acid with a “—C(═O)—Cl” group.

In the polycondensation of the bisphenol and the dicarboxylic acid, one or both of a base and a catalyst may be added. An example of the base is sodium hydroxide. Examples of the catalyst include benzyltributylammonium chloride, ammonium chloride, ammonium bromide, a quaternary ammonium salt, triethylamine, and trimethylamine.

The photosensitive layer may contain, as the binder resin, only the polyarylate resin (PAR), and may further contain a binder resin other than the foregoing (hereinafter sometimes referred to as “other binder resin”). Examples of the other binder resin include: thermoplastic resins (more specifically, a polyester resin other than the polyarylate resin (PAR), a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin); thermosetting resins (more specifically, a silicone resin, an epoxy resin, a phenol resin, a urea resin, a melamine resin, and any other crosslinkable thermosetting resin); and photocurable resins (more specifically, an epoxy-acrylic acid-based resin, and a urethane-acrylic acid-based copolymer).

In the electrophotographic photosensitive member of the present invention, a ratio of the resin having at least the structural unit represented by the formula (1) and the structural unit represented by the formula (2) in the binder resin is preferably 50 mass % or more. Further, in the electrophotographic photosensitive member of the present invention, a ratio of a mass of the polyarylate resin to the mass of the binder resin is preferably 50 mass % or more.

The structure of the polyarylate resin of the present invention may be determined by a ¹H-nuclear magnetic resonance spectrum obtained by performing component analysis of polymer components recovered from the photosensitive layer through use of ¹H-nuclear magnetic resonance spectrometry (proton NMR) in deuterated chloroform.

A specific analysis method for the polyarylate resin in the photosensitive layer when the photosensitive member is a cylindrical body is described below.

### (Reprecipitation of Resin in Photosensitive Layer)

The photosensitive member (cylindrical body) is cut at a position 10 cm distant from an end portion of the photosensitive member in a generating line direction with a scroll saw.
An inner surface of the cut cylindrical body of 10 cm is wiped with lens-cleaning paper impregnated with chloroform.
To elute the photosensitive layer, 3 cm of an end portion of the cut cylindrical body is immersed in chloroform. (About 60 ml of chloroform is loaded into a 100 mL beaker, and the end portion is immersed therein at normal temperature for 5 minutes.)
The chloroform solution in which the above-mentioned photosensitive layer has been eluted is concentrated to 2 mL with a rotary evaporator to provide a concentrated solution, and the concentration is stopped.
50 mL of a methanol/acetone mixed solution (volume ratio: 1:1) is prepared, and a whole amount of the above-mentioned concentrated solution is dropped thereinto while the mixed solution is stirred, to thereby perform reprecipitation.
Suction filtration is performed with a funnel (funnel: SU-40, paper filter: No. 5C-40, manufactured by Kiriyama Glass Co.).
A residue on the paper filter is recovered with a spatula and dried in a vacuum (70° C., 1 hour).

### (NMR Measurement)

To prepare a measurement sample, 20 mg of a sample is dissolved in 1 g of deuterated chloroform containing tetramethylsilane serving as a reference material, and a whole amount thereof is transferred to an NMR tube.
(Deuterated chloroform: manufactured by Sigma-Aldrich Japan G.K., chloroform-d, model number: 612200)
(NMR tube: manufactured by Norell, Inc., ST500-7, model number: S3010)
NMR measurement
   Apparatus: AVANCE 500 manufactured by Bruker
   Conditions: Proton NMR, automatic measurement by Icon-NMR
   Number of scans: 32
   Reference peak: A peak of a methyl group of tetramethylsilane is set to 0 ppm.

### [Charge Generating Material]

Examples of the charge generating material include a phthalocyanine-based pigment, a perylene-based pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, powder of an inorganic photoconductive material (e.g., selenium, selenium-tellurium, selenium-arsenic, cadmium sulfide, and amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The photosensitive layer may contain only one kind of charge generating material, or may contain two or more kinds of charge generating materials.

The phthalocyanine-based pigment is a pigment having a phthalocyanine structure. Examples of the phthalocyanine-based pigment include metal-free phthalocyanine and a metal phthalocyanine. Examples of the metal phthalocyanine include titanyl phthalocyanine, hydroxygallium phthalocyanine, and chlorogallium phthalocyanine. The metal phthalocyanine is preferably titanyl phthalocyanine. Titanyl phthalocyanine is represented by the formula (CGM-1).

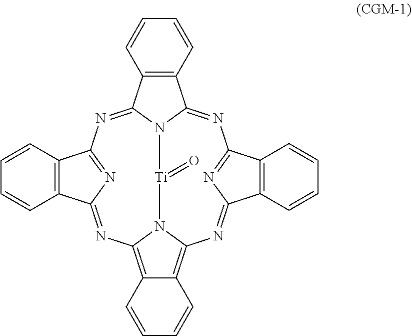

The phthalocyanine-based pigment may be crystalline or amorphous. An example of a crystal of metal-free phthalocyanine is an X-form crystal of metal-free phthalocyanine (the X-form crystal of metal-free phthalocyanine is hereinafter sometimes referred to as “X-form metal-free phthalocyanine”). Examples of a crystal of titanyl phthalocyanine include α-form, β-form, and Y-form crystals of titanyl phthalocyanine (the α-form, β-form, and Y-form crystals of titanyl phthalocyanine are hereinafter sometimes referred to as “α-form titanyl phthalocyanine,” “β-form titanyl phthalocyanine,” and “Y-form titanyl phthalocyanine,” respectively). For example, in a digital optical electrophotographic apparatus (e.g., a laser beam printer or a facsimile using a light source such as a semiconductor laser), a photosensitive member having sensitivity in a wavelength region of 700 nm or more is preferably used. The charge generating material preferably contains a phthalocyanine-based pigment, more preferably contains metal-free phthalocyanine or titanyl phthalocyanine, still more preferably contains titanyl phthalocyanine, and particularly preferably contains Y-form titanyl phthalocyanine because these materials each have a high quantum yield in a wavelength region of 700 nm or more.

The Y-form titanyl phthalocyanine has a main peak, for example, at a Bragg angle (2θ±0.2°) of 27.2° in a CuKα characteristic X-ray diffraction spectrum. The main peak in the CuKα characteristic X-ray diffraction spectrum is a peak having the first or second largest intensity in the range of a Bragg angle (2θ+0.2°) of 3° or more and 400 or less. The Y-form titanyl phthalocyanine does not have a peak at 26.2° in the CuKα characteristic X-ray diffraction spectrum.

The CuKα characteristic X-ray diffraction spectrum may be measured, for example, by the following method. First, a sample (titanyl phthalocyanine) is loaded into a sample holder of an X-ray diffraction apparatus (e.g., “RINT 1100” manufactured by Rigaku Corporation), and an X-ray diffraction spectrum is measured under conditions of an X-ray tube bulb of Cu, a tube voltage of 40 kV, a tube current of 30 mA, and a CuKα characteristic X-ray wavelength of 1.542 Å. A measurement range (2θ) is, for example, 3° or more and 400 or less (start angle: 3° and stop angle: 40°), and a scanning speed is, for example, 10°/min. The main peak is determined from the resultant X-ray diffraction spectrum, and the Bragg angle of the main peak is read.

The content of the charge generating material to 100 parts by mass of the binder resin is preferably 0.1 part by mass or more and 50 parts by mass or less, more preferably 0.5 part by mass or more and 5 parts by mass or less.

### [Electron Transporting Material]

In the electrophotographic apparatus of the present invention, it is preferred that the electron transporting material contain a compound represented by the following formula (10), a compound represented by the following formula (11), a compound represented by the following formula (12), a compound represented by the following formula (13), a compound represented by the following formula (14), a compound represented by the following formula (15), or a compound represented by the following formula (16). It is conceived that the incorporation of the above-mentioned electron transporting material into the photosensitive layer increases the compatibility between the binder resin and a hole transporting material to be described later in the present invention to increase uniformity of the photosensitive layer, to thereby enhance effects of the present invention.

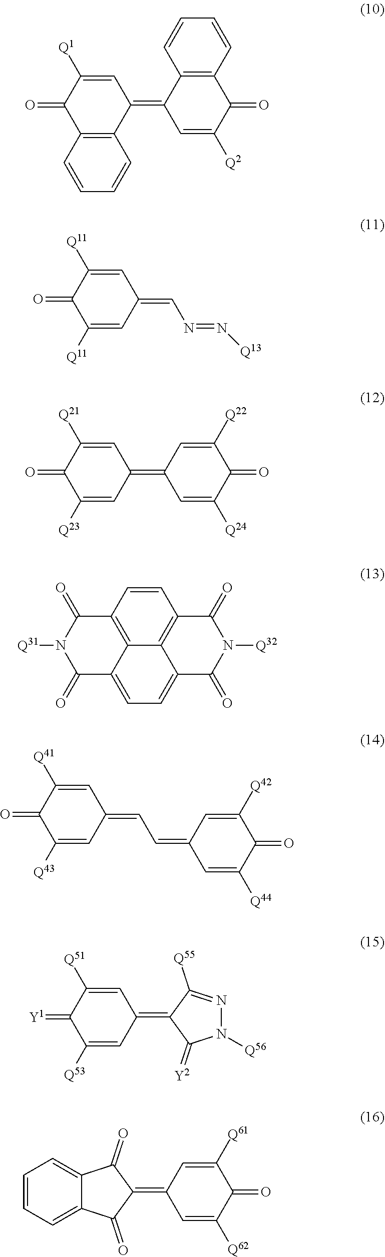

Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. Y¹ and Y² in the formula (15) each independently represent an oxygen atom or a sulfur atom.

It is preferred that Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16) each independently represent a hydrogen atom, an alkyl group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. It is preferred that Y¹ and Y² in the formula (15) each represent an oxygen atom.

The alkyl group having 1 or more and 6 or less carbon atoms, which is represented by each of Q¹ and Q² in the formula (10), Q¹¹ to Q³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16), is preferably an alkyl group having 1 or more and 5 or less carbon atoms, more preferably a methyl group, an ethyl group, a propyl group, a butyl group, or a pentyl group, particularly preferably a methyl group, an isopropyl group, a tert-butyl group, or a 1,1-dimethylpropyl group.

The aryl group having 6 or more and 14 or less carbon atoms, which is represented by each of Q¹ and Q² in the formula (10), Q¹¹ to Q³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16), is preferably an aryl group having 6 or more and 10 or less carbon atoms, more preferably a phenyl group. The aryl group having 6 or more and 14 or less carbon atoms may be substituted with at least one substituent selected from the group consisting of: an alkyl group having 1 or more and 6 or less carbon atoms; and a halogen atom. The alkyl group having 1 or more and 6 or less carbon atoms, which is a substituent, is preferably an alkyl group having 1 or more and 3 or less carbon atoms, more preferably a methyl group or an ethyl group. The halogen atom, which is a substituent, is preferably a fluorine atom, a chlorine atom, or a bromine atom, particularly preferably a chlorine atom. When the aryl group having 6 or more and 14 or less carbon atoms is substituted with a substituent, a number of substituents is preferably 1 or more and 5 or less, more preferably 1 or 2. The aryl group having 6 or more and 14 or less carbon atoms that is substituted with at least one substituent selected from the group consisting of: an alkyl group having 1 or more and 6 or less carbon atoms; and a halogen atom is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

The alkenyl group having 2 or more and 6 or less carbon atoms, which is represented by each of Q¹ and Q² in the formula (10), Q¹¹ to Q³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16), is preferably a vinyl group, a 1-propenyl group, a 2-propenyl group, a 1-methylvinyl group, a 1-butenyl group, a 1-ethylvinyl group, a 1-methyl-2-propenyl group, a 2-butenyl group, a 3-butenyl group, a 2-methyl-1-propenyl group, a 2-methyl-2-propenyl group, a pentenyl group, or a hexenyl group.

The alkoxy group having 1 or more and 6 or less carbon atoms, which is represented by each of Q¹ and Q² in the formula (10), Q¹¹ to Q³ in the formula (11), Q²¹ to Q²⁴ in the formula (12), Q³¹ and Q³² in the formula (13), Q⁴¹ to Q⁴⁴ in the formula (14), Q¹¹ to Q⁵⁶ in the formula (15), and Q⁶¹ and Q⁶² in the formula (16), is preferably a methoxy group, an ethoxy group, a n-propoxy group, an isopropoxy group, a n-butoxy group, an isobutoxy group, a tert-butoxy group, a pentoxy group, or a hexyloxy group.

In the electrophotographic apparatus of the present invention, it is preferred that the electron transporting material contain a compound represented by the following formula (E-1), a compound represented by the following formula (E-2), a compound represented by the following formula (E-3), a compound represented by the following formula (E-4), a compound represented by the following formula (E-5), a compound represented by the following formula (E-6), a compound represented by the following formula (E-7), or a compound represented by the following formula (E-8). A suitable example of the compound represented by the formula (10) (hereinafter sometimes referred to as “electron transporting material (10)”) is the compound represented by the following formula (E-4). A suitable example of the electron transporting material (11) is the compound represented by the following formula (E-5). A suitable example of the electron transporting material (12) is the compound represented by the following formula (E-7). A suitable example of the electron transporting material (13) is the compound represented by the following formula (E-6). A suitable example of the electron transporting material (14) is the compound represented by the following formula (E-8). Suitable examples of the electron transporting material (15) include the compounds represented by the following formula (E-2) and the following formula (E-3). A suitable example of the electron transporting material (16) is the compound represented by the following formula (E-1). The compounds represented by the following formula (E-1) to the following formula (E-8) are hereinafter sometimes referred to as “electron transporting material (E-1)” to “electron transporting material (E-8),” respectively.

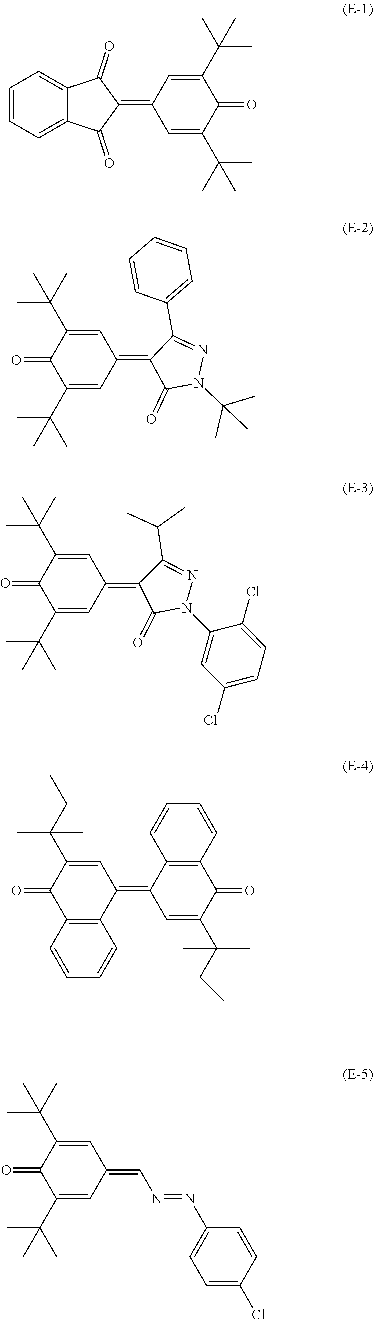

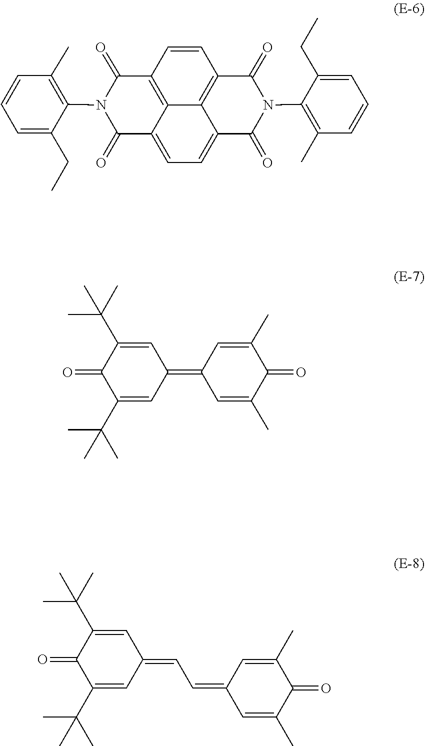 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

A content of the electron transporting material to 100 parts by mass of the binder resin is preferably 5 parts by mass or more and 150 parts by mass or less, more preferably 10 parts by mass or more and 100 parts by mass or less, still more preferably 30 parts by mass or more and 70 parts by mass or less. The photosensitive layer may contain only one kind of electron transporting material, or may contain two or more kinds of electron transporting materials.

### [Hole Transporting Material]

In the electrophotographic photosensitive member of the present invention, it is preferred that the hole transporting material contain a compound represented by the following formula (20), a compound represented by the following formula (21), a compound represented by the following formula (22), a compound represented by the following formula (23), or a compound represented by the following formula (24). It is conceived that incorporation of the above-mentioned hole transporting material into the photosensitive layer increases compatibility between the binder resin and the electron transporting material in the present application to increase the uniformity of the photosensitive layer, to thereby enhance the effects of the present invention.

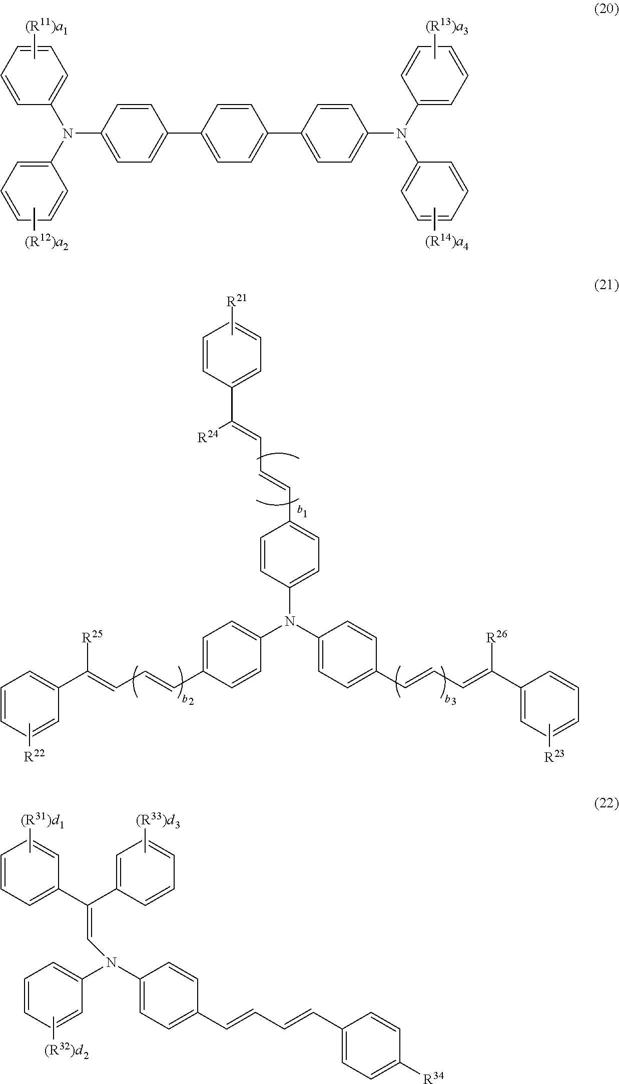

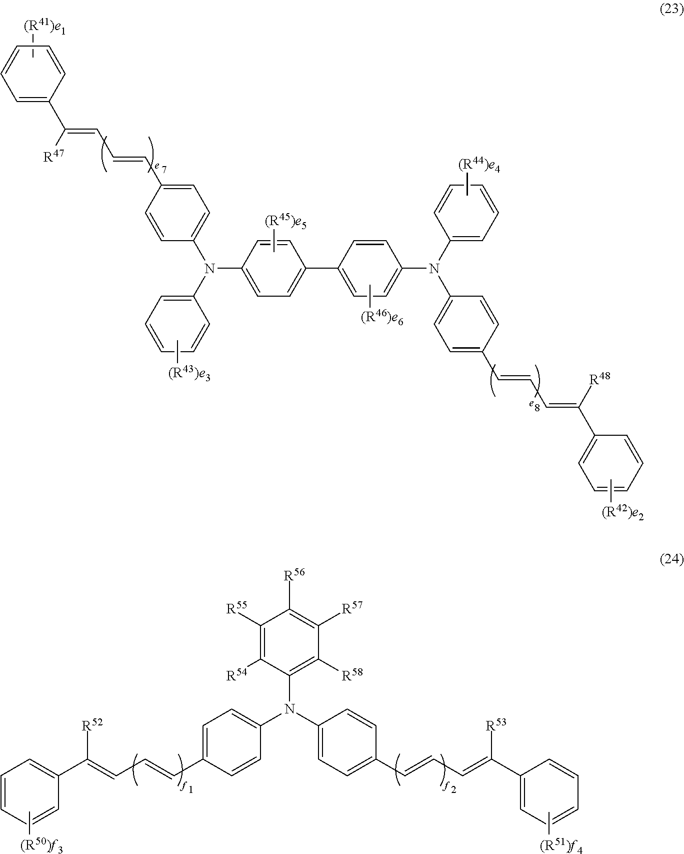

In the formula (20), R^{D}, R¹², R¹³, and R¹⁴ each independently represent an alkyl group having 1 or more and 6 or less carbon atoms, or an alkoxy group having 1 or more and 6 or less carbon atoms, and a₁, a₂, a₃, and a₄ each independently represent an integer of 0 or more and 5 or less. In the formula (20), when a₁ represents an integer of 2 or more and 5 or less, a plurality of R¹¹s may represent groups identical to or different from each other. When a₂ represents an integer of 2 or more and 5 or less, a plurality of R¹²s may represent groups identical to or different from each other. When a₃ represents an integer of 2 or more and 5 or less, a plurality of R¹³s may represent groups identical to or different from each other. When a₄ represents an integer of 2 or more and 5 or less, a plurality of R¹⁴s may represent groups identical to or different from each other. In the formula (20), R¹¹, R¹², R¹³, and R¹⁴ each independently represent preferably an alkyl group having 1 or more and 3 or less carbon atoms, more preferably a methyl group or an ethyl group. a₁, a₂, a₃, and a₄ each independently represent preferably an integer of 1 or more and 3 or less, more preferably 1. R¹¹, R¹², R¹³, and R¹⁴ each independently represent preferably an alkoxy group having 1 or more and 6 or less carbon atoms, more preferably a methoxy group, an ethoxy group, a n-propoxy group, an isopropoxy group, a n-butoxy group, an isobutoxy group, a tert-butoxy group, a pentoxy group, and a hexyloxy group.

In the formula (21), R²¹, R²², and R²³ each independently represent preferably an alkyl group having 1 or more and 6 or less carbon atoms, more preferably a methyl group, an ethyl group, a n-propyl group, an isopropyl group, a n-butyl group, an isobutyl group, a tert-butyl group, a pentyl group, or a hexyl group, R²⁴, R²⁵, and R²⁶ each independently represent preferably a hydrogen atom, or an alkyl group having 1 or more and 6 or less carbon atoms, more preferably a methyl group, an ethyl group, a n-propyl group, an isopropyl group, a n-butyl group, an isobutyl group, a tert-butyl group, a pentyl group, or a hexyl group, and b₁, b₂, and b₃ each independently represent 0 or 1. In the formula (21), R²¹, R²², and R²³ each independently represent preferably an alkyl group having 1 or more and 3 or less carbon atoms, more preferably a methyl group, an ethyl group, a n-propyl group, or an isopropyl group, particularly preferably a methyl group. R²¹, R²², and R²³ are each preferably bonded to the meta-position of a phenyl group with respect to an ethenyl group or a butadienyl group. R²⁴, R²⁵, and R²⁶ each preferably represent a hydrogen atom. It is preferred that all of b₁, b₂, and b₃ represent 0 or represent 1.

In the formula (22), R³¹, R³², and R³³ each independently represent preferably an alkyl group having 1 or more and 6 or less carbon atoms, more preferably a methyl group, an ethyl group, a n-propyl group, an isopropyl group, a n-butyl group, an isobutyl group, a tert-butyl group, a pentyl group, or a hexyl group, R³⁴ represents preferably an alkyl group having 1 or more and 6 or less carbon atoms, or a hydrogen atom, more preferably a methyl group, an ethyl group, a n-propyl group, an isopropyl group, a n-butyl group, an isobutyl group, a tert-butyl group, a pentyl group, a hexyl group, or a hydrogen atom, and d₁, d₂, and d₃ each independently represent an integer of 0 or more and 5 or less. In the formula (22), when d₁ represents an integer of 2 or more and 5 or less, a plurality of R³¹ may represent groups identical to or different from each other. When d₂ represents an integer of 2 or more and 5 or less, a plurality of R³² may represent groups identical to or different from each other. When d₃ represents an integer of 2 or more and 5 or less, a plurality of R³³ may represent groups identical to or different from each other. In the formula (22), R³⁴ preferably represents a hydrogen atom. d¹, d², and d³ each preferably represent 0.

In the formula (23), R⁴¹, R⁴², R⁴³, R⁴⁴, R⁴⁵, and R⁴⁶ each independently represent preferably an alkyl group having 1 or more and 6 or less carbon atoms, or a phenyl group, more preferably a methyl group, an ethyl group, a n-propyl group, an isopropyl group, a n-butyl group, an isobutyl group, a tert-butyl group, a pentyl group, a hexyl group, or a phenyl group, R⁴⁷ and R⁴⁸ each independently represent preferably a hydrogen atom, an alkyl group having 1 or more and 6 or less carbon atoms, or a phenyl group, more preferably a methyl group, an ethyl group, a n-propyl group, an isopropyl group, a n-butyl group, an isobutyl group, a tert-butyl group, a pentyl group, a hexyl group, or a phenyl group, e₁, e₂, e₃, and e₄ each independently represent an integer of 0 or more and 5 or less, e₅ and e₆ each independently represent an integer of 0 or more and 4 or less, and e₇ and e₈ each independently represent 0 or 1. In the formula (23), when e₁ represents an integer of 2 or more and 5 or less, a plurality of R⁴¹ may represent groups identical to or different from each other. When e₂ represents an integer of 2 or more and 5 or less, a plurality of R⁴² may represent groups identical to or different from each other. When e₃ represents an integer of 2 or more and 5 or less, a plurality of R⁴³ may represent groups identical to or different from each other. When e₄ represents an integer of 2 or more and 5 or less, a plurality of R⁴⁴ may represent groups identical to or different from each other. When e₅ represents an integer of 2 or more and 4 or less, a plurality of R⁴⁵ may represent groups identical to or different from each other. When e₆ represents an integer of 2 or more and 4 or less, a plurality of R⁴⁶ may represent groups identical to or different from each other. In the formula (23), R⁴¹ to R⁴⁶ each independently represent preferably an alkyl group having 1 or more and 6 or less carbon atoms, more preferably an alkyl group having 1 or more and 3 or less carbon atoms, still more preferably a methyl group or an ethyl group. R⁴⁷ and R⁴⁸ each preferably represent a hydrogen atom. It is preferred that e₁, e₂, e₃, and e₄ each independently represent an integer of 0 or more and 2 or less. It is more preferred that e₁ and e₂ each represent 0, and e₃ and e₄ each represent 2. e₅ and e₆ each preferably represent 0. It is preferred that e₇ and e₈ all represent 0 or all represent 1.

In the formula (24), R⁵⁰ and R⁵¹ each independently represent an alkyl group having 1 or more and 6 or less carbon atoms, an alkoxy group having 1 or more and 6 or less carbon atoms, or a phenyl group, and R⁵², R⁵³, R⁵⁴, R⁵⁵, R⁵⁶, R⁵⁷, and R^{5′} each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms. The alkyl group having 1 or more and 6 or less carbon atoms preferably represents a methyl group, an ethyl group, a n-propyl group, an isopropyl group, a n-butyl group, an isobutyl group, a tert-butyl group, a pentyl group, or a hexyl group. The alkoxy group having 1 or more and 6 or less carbon atoms preferably represents a methoxy group, an ethoxy group, a n-propoxy group, an isopropoxy group, a n-butoxy group, an isobutoxy group, a tert-butoxy group, a pentoxy group, or a hexyloxy group. f₁ and f₂ each independently represent an integer of 0 or more and 2 or less, and f₃ and f₄ each independently represent an integer of 0 or more and 5 or less. In the formula (24), when f₃ represents an integer of 2 or more and 5 or less, a plurality of R⁵⁰s may represent groups identical to or different from each other. When f₄ represents an integer of 2 or more and 5 or less, a plurality of R⁵¹s may represent groups identical to or different from each other.

In the formula (24), R⁵⁰ and R⁵¹ each independently represent preferably an alkyl group having 1 or more and 6 or less carbon atoms, more preferably a methyl group, an ethyl group, a n-propyl group, an isopropyl group, a n-butyl group, an isobutyl group, a tert-butyl group, a pentyl group, or a hexyl group. It is preferred that R₅₂ and R₅₃ each represent a hydrogen atom, or a phenyl group that may be substituted with an alkyl group having 1 or more and 6 or less carbon atoms. Herein, the alkyl group having 1 or more and 6 or less carbon atoms is preferably a methyl group, an ethyl group, a n-propyl group, an isopropyl group, a n-butyl group, an isobutyl group, a tert-butyl group, a pentyl group, or a hexyl group. It is preferred that R⁵⁴ to R⁵⁸ each independently represent a hydrogen atom, an alkyl group having 1 or more and 6 or less carbon atoms, or an alkoxy group having 1 or more and 6 or less carbon atoms. Herein, the alkyl group having 1 or more and 6 or less carbon atoms preferably represents a methyl group, an ethyl group, a n-propyl group, an isopropyl group, a n-butyl group, an isobutyl group, a tert-butyl group, a pentyl group, or a hexyl group. The alkoxy group having 1 or more and 6 or less carbon atoms preferably represents a methoxy group, an ethoxy group, a n-propoxy group, an isopropoxy group, a n-butoxy group, an isobutoxy group, a tert-butoxy group, a pentoxy group, or a hexyloxy group. It is preferred that f₁ and f₂ all represent 0, all represent 1, or all represent 2. It is preferred that f₃ and f₄ each independently represent 0 or 1.

The alkyl group having 1 or more and 6 or less carbon atoms, which is represented by each of R¹⁰ and R¹, is preferably an alkyl group having 1 or more and 3 or less carbon atoms, more preferably a methyl group, an ethyl group, a n-propyl group, or an isopropyl group, particularly preferably a methyl group. The phenyl group that may be substituted with an alkyl group having 1 or more and 6 or less carbon atoms, which is represented by each of R⁵² and R³, is preferably a phenyl group, or a phenyl group that is substituted with an alkyl group having 1 or more and 3 or less carbon atoms. The phenyl group that is substituted with an alkyl group having 1 or more and 3 or less carbon atoms is preferably a methylphenyl group, more preferably a 4-methylphenyl group. The alkyl group having 1 or more and 6 or less carbon atoms, which is represented by each of R⁵⁴ to R⁸, is preferably an alkyl group having 1 or more and 4 or less carbon atoms, and more preferably represents a methyl group, an ethyl group, or a n-butyl group. The alkoxy group having 1 or more and 6 or less carbon atoms, which is represented by each of R¹⁴ to R⁵⁸, is preferably an alkoxy group having 1 or more and 3 or less carbon atoms, more preferably a methoxy group, an ethoxy group, a n-propoxy group, or an isopropoxy group, particularly preferably an ethoxy group.

In the electrophotographic apparatus of the present invention, it is preferred that the hole transporting material contain a compound represented by the following formula (H-1), a compound represented by the following formula (H-2), a compound represented by the following formula (H-3), a compound represented by the following formula (H-4), a compound represented by the following formula (H-5), a compound represented by the following formula (H-6), a compound represented by the following formula (H-7), a compound represented by the following formula (H-8), a compound represented by the following formula (H-9), a compound represented by the following formula (H-10), or a compound represented by the following formula (H-11). A suitable example of the hole transporting material (20) is the compound represented by the following formula (H-11). Suitable examples of the hole transporting material (21) include the compounds represented by the following formula (H-7) and the following formula (H-8). A suitable example of the hole transporting material (22) is the compound represented by the following formula (H-6). Suitable examples of the hole transporting material (23) include the compounds represented by the following formula (H-9) and the following formula (H-10). Suitable examples of the hole transporting material (24) include the compounds represented by the following formula (H-1), the following formula (H-2), the following formula (H-3), the following formula (H-4), and the following formula (H-5). The compounds represented by the following formula (H-1) to the following formula (H-11) are hereinafter sometimes referred to as “hole transporting material (H-1)” to “hole transporting material (H-11),” respectively.

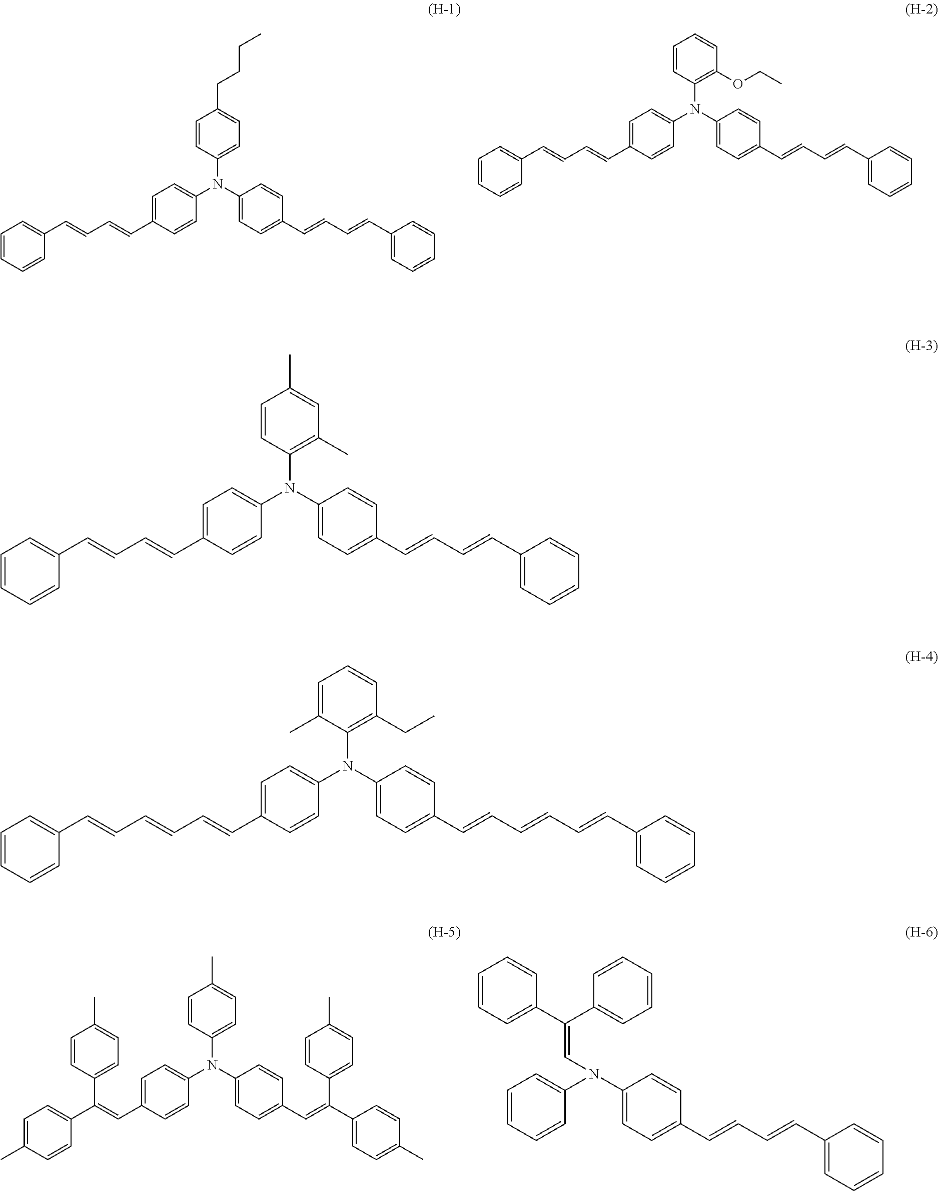

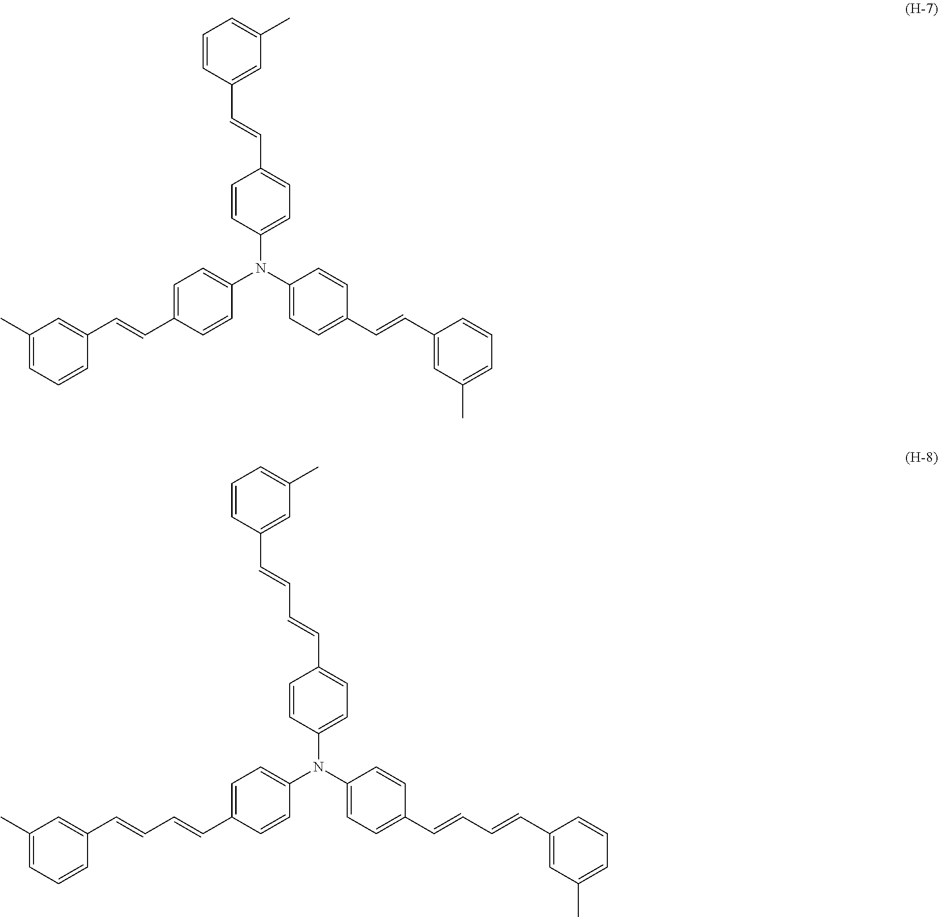 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

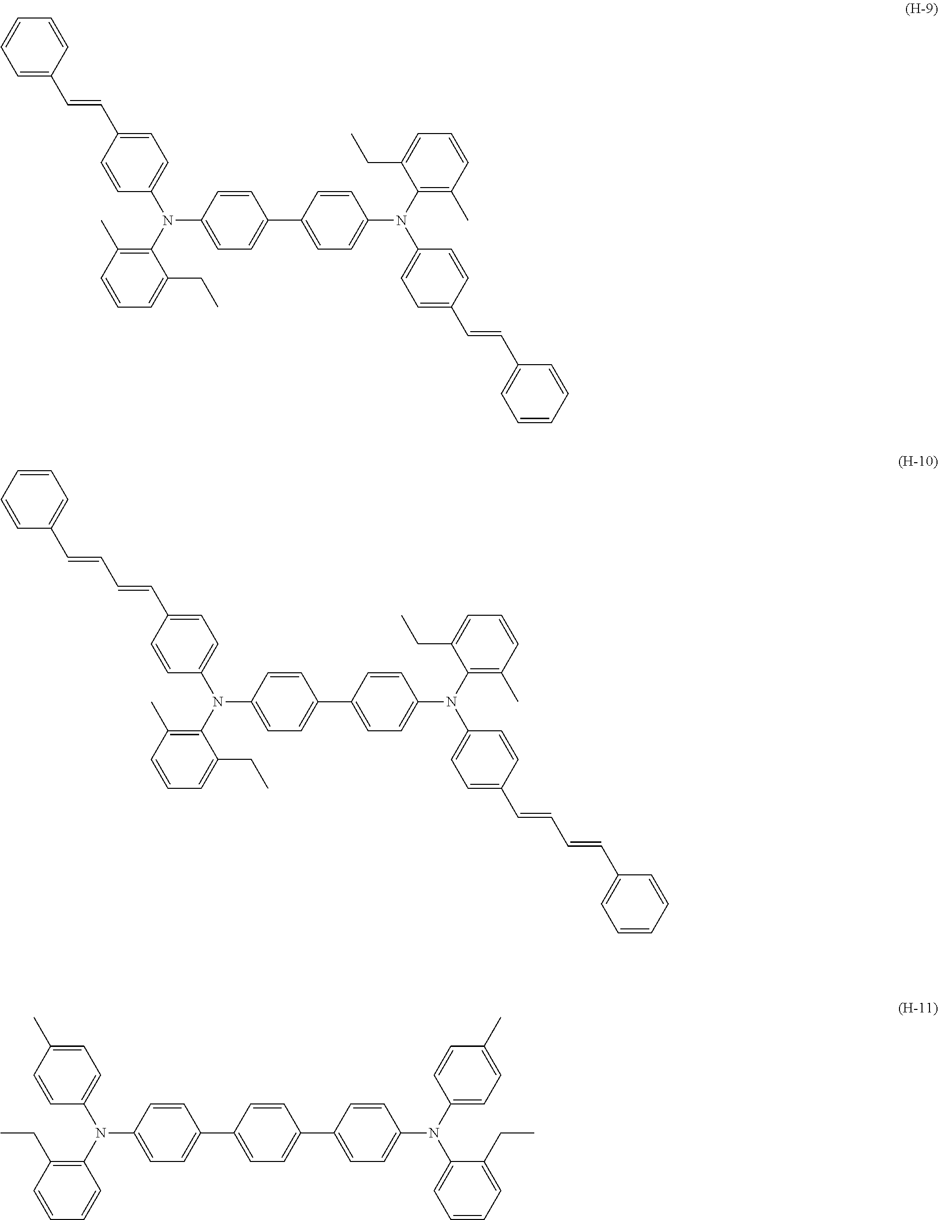 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content of the hole transporting material to 100 parts by mass of the binder resin is preferably 10 parts by mass or more and 200 parts by mass or less, more preferably 30 parts by mass or more and 120 parts by mass or less, still more preferably 50 parts by mass or more and 90 parts by mass or less. The photosensitive layer may contain only one kind of hole transporting material, or may contain two or more kinds of hole transporting materials. In addition, the photosensitive layer may further contain a hole transporting material other than the compound represented by the formula (20), the compound represented by the formula (21), the compound represented by the formula (22), the compound represented by the formula (23), and the compound represented by the formula (24) (hereinafter sometimes referred to as “other hole transporting material”). Examples of the other hole transporting material include triphenylamine derivatives, diamine derivatives (e.g., N,N,N′,N′-tetraphenylbenzidine derivatives, N,N,N′,N′-tetraphenylphenylenediamine derivatives, N,N,N′,N′-tetraphenylnaphthylenediamine derivatives, N,N,N′,N′-tetraphenylphenanthrylenediamine derivatives, and di(aminophenylethenyl)benzene derivatives), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinylcarbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

### [Additive]

In the electrophotographic photosensitive member of the present invention, it is preferred that the photosensitive layer contain, as an additive, a compound represented by the following formula (T-1). The photosensitive layer may contain an additive as required. Examples of the additive include a UV absorber, an antioxidant, a radical scavenger, a singlet quencher, a softener, a surface modifier, an extender, a thickener, a wax, a donor, a surfactant, a plasticizer, a sensitizer, and a leveling agent. In particular, it is preferred to add a small amount of the substance represented by the formula (T-1).

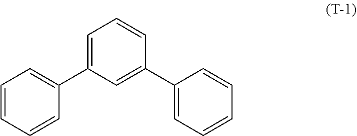 [SMILES: c1ccc(-c2cccc(-c3ccccc3)c2)cc1]

### [Toner]

In the electrophotographic apparatus of the present invention, the toner is toner that expresses positive chargeability and contains toner particles.

### [Toner Particle]

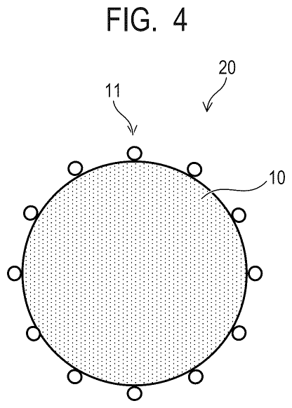

FIG. 4 is a view for illustrating an example of a sectional structure of a toner particle in the toner of this embodiment. A toner particle 20 illustrated in FIG. 4 contains a toner base particle 10 and an external additive adhering to a surface of the toner base particle 10. An external additive contains alumina particles 11. A structure of the toner particle in the toner has been described above with reference to FIG. 4. The toner particle in the toner of the present invention may have a structure different from that of the toner particle 20 illustrated in FIG. 4. For example, the toner base particle may have a core-shell structure.

The toner of the present invention is further described below.

### [External Additive]

In the electrophotographic apparatus of the present invention, the toner particles each contain a toner base particle and an external additive adhering to the surface of the toner base particle, and the external additive contains alumina particles. In addition, the external additive preferably contains organic particles, silica particles, etc. in addition to the alumina particles in order to improve performance of the toner. (An external additive other than the alumina particles is hereinafter referred to as “other external additive”).

### [Alumina Particle]

In the electrophotographic apparatus of the present invention, it is preferred that the toner base particles each contain a binder resin, and an amount of aluminum oxide particles (alumina particles) serving as an external additive to 100 parts by mass of the toner base particles is 0.1 part by mass or more and 3.0 parts by mass or less.

In the electrophotographic apparatus of the present invention, a number-average value of long diameters of the aluminum oxide particles (number-average primary particle diameter of the alumina particles) is preferably 10 nm or more and 450 nm or less, more preferably 60 nm or more and 450 nm or less. When the number-average value of long diameters is set to those ranges, desorption of the alumina particles from the toner base particles can be suppressed, and an image having a desired image density is easily formed even when a large number of images are printed.

The amount of the alumina particles to 100 parts by mass of the toner base particles is preferably 0.1 part by mass or more and 10 parts by mass or less, more preferably 0.1 part by mass or more and 5 parts by mass or less. The amount of the alumina particles to 100 parts by mass of the external additive is preferably 20 parts by mass or more and 60 parts by mass or less, more preferably 30 parts by mass or more and 50 parts by mass or less.

The alumina particles each may include an electroconductive layer that covers an alumina substrate and a surface treatment layer that covers an electroconductive layer in addition to an alumina substrate to an extent that the positive chargeability is not impaired.

### [Alumina Substrate]

The alumina substrate tends to exhibit positive chargeability, and hence the toner containing the alumina particles is easily positively charged. A content ratio of the alumina substrate in the alumina particle is preferably 80 mass % or more, more preferably 95 mass % or more, still more preferably 100 mass %.

The alumina substrate may be obtained, for example, by firing aluminum hydroxide and then pulverizing a resultant with a pulverizer, or commercially available alumina powder may be used. An example of the commercially available alumina powder is high-purity alumina (AKP series) manufactured by Sumitomo Chemical Co., Ltd.

### [Electroconductive Layer]

The electroconductive layer is a layer formed with an electroconductive treatment agent. The alumina particles serving as an external additive each include an electroconductive layer, and hence an electroconductivity of the toner is appropriately increased.

The electroconductive layer preferably contains an oxide having electroconductivity, and more preferably contains a metal oxide having electroconductivity (the metal oxide having electroconductivity is hereinafter sometimes referred to as “electroconductive metal oxide”). Examples of the electroconductive metal oxide include: metal oxides each containing tin oxide (e.g., antimony-doped tin oxide (ATO), indium tin oxide (ITO), and fluorine-doped tin oxide (FTO)); and metal oxides each containing zinc oxide (e.g., aluminum-doped zinc oxide (AZO) and gallium-doped zinc oxide (GZO)). The electroconductive layer preferably contains antimony-doped tin oxide. A content ratio of the electroconductive metal oxide in the electroconductive layer is preferably 80 mass % or more, more preferably 95 mass % or more, still more preferably 100 mass %.

### [Surface Treatment Layer]

The surface treatment layer is a layer formed with a surface treatment agent. The surface treatment layer imparts satisfactory charging stability to the toner while suppressing peeling of the electroconductive layer. The surface treatment agent is, for example, a hydrophobization treatment agent. Specific examples of the surface treatment agent include a titanate coupling agent, an aluminate coupling agent, and a fatty acid metal salt.

The alumina particles may each further include another layer in addition to the electroconductive layer and the surface treatment layer. In addition, the electroconductive layer may cover the substrate directly or indirectly. In addition, the surface treatment layer may cover the electroconductive layer directly or indirectly. In addition, the electroconductive layer and the surface treatment layer may each be a multilayer.

<Method of measuring Number-average Particle Diameter of Alumina Particles>

A method of measuring the number-average particle diameter of the alumina particles is described.

First, locations of the alumina particles present on a surface of the toner are identified. The locations of the alumina particles may be identified by observation with an ultra-high resolution field emission scanning electron microscope S-4800 ((Hitachi High-Technologies Corporation) (SEM-EDX)) and by elemental analysis.

Next, the long diameters of at least 200 alumina particles on the identified surface of the toner are measured, and an average thereof is determined. Although some alumina particles are present as aggregated particles, such aggregated particles are not subject to particle diameter measurement. In addition, a maximum diameter of each of the particles is used as the long diameter.

### [Other External Additive]

In the electrophotographic apparatus of the present invention, the external additive may contain strontium titanate particles. Examples of the other external additive include: fluorine-based resin particles, such as vinylidene fluoride fine particles and polytetrafluoroethylene fine powder; silica fine particles, such as wet process silica and dry process silica, titanium oxide fine particles; hydrophobization-treated fine particles obtained by subjecting the above-mentioned particles to surface treatment with a hydrophobization treatment agent, such as a silane compound, a titanium coupling agent, or a silicone oil; oxides, such as zinc oxide and tin oxide; composite oxides, such as strontium titanate, barium titanate, calcium titanate, strontium zirconate, and calcium zirconate; and carbonic acid salt compounds, such as calcium carbonate and magnesium carbonate.

In the electrophotographic apparatus of the present invention, the external additive may contain fluorine-based resin particles. In particular, the fluorine-based resin particles are preferred because particles improve the fluidity of the toner, and partially impart positive charge to the toner when being desorbed from the toner, resulting in an improvement in positive charging stability of the toner.

### [Toner Base Particle]

The toner base particle contains a binder resin as a main component. In addition, the toner base particle may contain an internal additive as required. Examples of the internal additive include a colorant, a release agent, a charge control agent, a charge control resin, and magnetic powder.

### [Binder Resin]

Examples of the binder resin include a vinyl-based resin, a polyester resin, a polyurethane resin, and an epoxy resin, which have been hitherto known. Of those, a vinyl-based resin, a polyester resin, and a polyurethane resin are preferred from the viewpoint of electrophotographic characteristics.

As the vinyl-based resin, there may be used, for example: homopolymers of styrene and substituted products thereof, such as polystyrene, poly-p-chlorostyrene, and polyvinyltoluene; styrene-based copolymers, such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-methyl α-chloromethacrylate copolymer, a styrene-acrylonitrile copolymer, a styrene-vinyl methyl ether copolymer, a styrene-vinyl ethyl ether copolymer, a styrene-vinyl methyl ketone copolymer, and a styrene-acrylonitrile-indene copolymer; and polyvinyl chloride, polyvinyl acetate, a xylene resin, polyvinyl butyral, and a petroleum-based resin.

In particular, a styrene-based copolymer, such as a styrene-acrylic acid ester copolymer or a styrene-methacrylic acid ester copolymer, is preferred.

### [Polymerizable Monomer]

A vinyl-based polymerizable monomer that is radically polymerizable may be used as a polymerizable monomer to be used in the styrene-based copolymer. A monofunctional polymerizable monomer or a polyfunctional polymerizable monomer may be used as the vinyl-based polymerizable monomer.

Examples of the monofunctional polymerizable monomer include: styrene; styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers, such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers, such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters, such as vinyl acetate, vinyl propionate, vinyl butyrate, vinyl benzoate, and vinyl formate; vinyl ethers, such as vinyl methyl ether, vinyl ethyl ether, and vinyl isobutyl ether; and vinyl ketones, such as vinyl methyl ketone, vinyl hexyl ketone, and vinyl isopropyl ketone.

Examples of the polyfunctional polymerizable monomer include diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy-diethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy-diethoxy)phenyl)propane, 2,2′-bis(4-(methacryloxy-polyethoxy)phenyl)propane, trimethylolpropane trimethacrylate, tetramethylolmethane tetramethacrylate, divinylbenzene, divinylnaphthalene, and divinyl ether.

The above-mentioned monofunctional polymerizable monomers are used alone or in combination thereof, or the above-mentioned monofunctional polymerizable monomers and polyfunctional polymerizable monomers are used in combination.

The polymerizable monomer to be used other than styrene is preferably a styrene derivative, an acrylic polymerizable monomer, such as n-butyl acrylate or 2-ethylhexyl acrylate, or a methacrylic polymerizable monomer, such as n-butyl methacrylate or 2-ethylhexyl methacrylate. This is because such polymerizable monomer is excellent in terms of strength and flexibility of a binder resin obtained by polymerizing the polymerizable monomer.

The polyester resin may be obtained by a reaction between a polyvalent carboxylic acid that is divalent or higher, and a polyhydric alcohol.

Examples of the polyvalent carboxylic acid include the following compounds: dibasic acids, such as succinic acid, adipic acid, sebacic acid, phthalic acid, isophthalic acid, terephthalic acid, malonic acid, and dodecenylsuccinic acid, and anhydrides thereof or lower alkyl esters thereof, and aliphatic unsaturated dicarboxylic acids, such as maleic acid, fumaric acid, itaconic acid, and citraconic acid.

The examples also include 1,2,4-benzenetricarboxylic acid, 1,2,5-benzenetricarboxylic acid, and anhydrides thereof or lower alkyl esters thereof. Those polyvalent carboxylic acids may be used alone or in combination thereof.

Examples of the polyhydric alcohol may include the following compounds: alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. The alkyl moiety of each of the alkylene glycol and the alkylene ether glycol may be linear or branched. The examples further include glycerin, trimethylolethane, trimethylolpropane, and pentaerythritol. Those polyhydric alcohols may be used alone or in combination thereof.

A monovalent acid, such as acetic acid or benzoic acid, and a monohydric alcohol, such as cyclohexanol or benzyl alcohol, may also be used as required for the purpose of adjusting an acid value and a hydroxyl value.

A method of producing the polyester resin is not particularly limited, but for example, an ester exchange method and a direct polycondensation method may be used alone or in combination thereof.

Next, the polyurethane resin is described. The polyurethane resin is a reaction product between a diol and a substance containing a diisocyanate group, and resins having various functionalities may be obtained by adjusting the diol and the diisocyanate.

Examples of the diisocyanate component include the following compounds: aromatic diisocyanates each having 6 or more and 20 or less carbon atoms (except a carbon atom in an NCO group, the same applies hereinafter); aliphatic diisocyanates each having 2 or more and 18 or less carbon atoms; alicyclic diisocyanates each having 4 or more and 15 or less carbon atoms; and modified products (urethane group, carbodiimide group, allophanate group, urea group, biuret group, uretdione group, uretimine group, isocyanurate group, and oxazolidone group-containing modified products, hereinafter sometimes referred to as “modified diisocyanates”) of those diisocyanates; and mixtures of two or more kinds thereof.

Examples of the aromatic diisocyanate include the following compounds: m- and/or p-xylylene diisocyanate (XDI); and α,α,α′,α′-tetramethylxylylene diisocyanate.

In addition, examples of the aliphatic diisocyanate include the following compounds: ethylene diisocyanate; tetramethylene diisocyanate; hexamethylene diisocyanate (HDI); and dodecamethylene diisocyanate.

In addition, examples of the alicyclic diisocyanate include the following compounds: isophorone diisocyanate (IPDI); dicyclohexylmethane-4,4′-diisocyanate; cyclohexylene diisocyanate; and methylcyclohexylene diisocyanate.

Of those, aromatic diisocyanates each having 6 or more and 15 or less carbon atoms, aliphatic diisocyanates each having 4 or more and 12 or less carbon atoms, and alicyclic diisocyanates each having 4 or more and 15 or less carbon atoms are preferred, and XDI, IPDI, and HDI are particularly preferred.

In addition, a tri- or higher functional isocyanate compound may be used in addition to the diisocyanate component.

A same alcohol as the above-mentioned dihydric alcohol that may be used in the polyester resin may be adopted as the diol component that may be used in the polyurethane resin.

### [Colorant]

The toner base particle may contain a colorant. A known pigment or dye may be used as the colorant in accordance with the color of the toner. To form a high-quality image through use of the toner, an amount of the colorant to 100 parts by mass of the binder resin is preferably 1 part by mass or more and 20 parts by mass or less, more preferably 2 parts by mass or more and 10 parts by mass or less.

The toner base particle may contain a black colorant. An example of a black colorant is carbon black. In addition, the black colorant may be a colorant toned to black color through use of a yellow colorant, a magenta colorant, and a cyan colorant. The toner base particle may contain a color colorant, such as a yellow colorant, a magenta colorant, or a cyan colorant.

For example, one or more kinds of compounds selected from the group consisting of: a condensed azo compound; an isoindolinone compound; an anthraquinone compound; an azo metal complex; a methine compound; and an arylamide compound may each be used as the yellow colorant. C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, or C.I. Vat Yellow classified by a color index may be suitably used as the yellow colorant.

One or more kinds of compounds selected from the group consisting of: a condensed azo compound; a diketopyrrolopyrrole compound; an anthraquinone compound; a quinacridone compound; a basic dye lake compound; a naphthol compound; a benzimidazolone compound; a thioindigo compound; and a perylene compound may each be used as the magenta colorant. C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254) classified by a color index may be suitably used as the magenta colorant.

For example, one or more kinds of compounds selected from the group consisting of: a copper phthalocyanine compound; an anthraquinone compound; and a basic dye lake compound may each be used as the cyan colorant. C.I. Pigment Blue (1, 7, 15, 15:1, 15:2, 15:3, 15:4, 60, 62, or 66), Phthalocyanine Blue, C.I. Vat Blue, or C.I. Acid Blue classified by a color index may be suitably used as the cyan colorant.

### [Release Agent]

The toner particle may contain a release agent.

Examples of the release agent include: waxes each containing a fatty acid ester as a main component, such as a carnauba wax and a montanic acid ester wax; a wax obtained by removing part or the whole of an acid component from a fatty acid ester such as a deacidified carnauba wax; a methyl ester compound having a hydroxy group obtained by hydrogenating a plant oil and fat; saturated fatty acid monoesters, such as stearyl stearate and behenyl behenate; diesterified products of a saturated aliphatic dicarboxylic acid and a saturated aliphatic alcohol, such as dibehenyl sebacate, distearyl dodecanedioate, and distearyl octadecanedioate; diesterified products of a saturated aliphatic diol and a saturated fatty acid, such as nonanediol dibehenate and dodecanediol distearate; aliphatic hydrocarbon-based waxes, such as low-molecular-weight polyethylene, low-molecular-weight polypropylene, a microcrystalline wax, a paraffin wax, and a Fischer-Tropsch wax; an oxide of an aliphatic hydrocarbon-based wax such as a polyethylene oxide wax, or a block copolymer thereof, waxes each obtained by grafting an aliphatic hydrocarbon-based wax with a vinyl-based monomer, such as styrene or acrylic acid; saturated linear fatty acids, such as palmitic acid, stearic acid, and montanoic acid; unsaturated fatty acids, such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols such as sorbitol; fatty acid amides, such as linoleamide, oleamide, and lauramide; saturated fatty acid bisamides, such as methylenebisstearamide, ethylenebiscapramide, ethylenebislauramide, and hexamethylenebisstearamide; unsaturated fatty acid amides, such as ethylenebisoleamide, hexamethylenebisoleamide, N,N′-dioleyladipamide, and N,N′-dioleylsebacamide; aromatic bisamides, such as m-xylenebisstearamide and N,N′-distearylisophthalamide; aliphatic metal salts, such as calcium stearate, calcium laurate, zinc stearate, and magnesium stearate (generally referred to as “metal soap”); and long-chain alkyl alcohols or long-chain alkyl carboxylic acids each having 12 or more carbon atoms.

A content of the release agent in the toner particle is preferably from 1.0 mass % to 30.0 mass %, more preferably from 2.0 mass % to 25.0 mass %.

[Charge Control Agent having Positive Chargeability and Charge Control Resin having Positive Chargeability]

The toner preferably contains at least one selected from the group consisting of: a charge control agent having positive chargeability; and a charge control resin having positive chargeability.

When the charge control agent having positive chargeability or the charge control resin having positive chargeability is used, and an addition amount thereof is adjusted, the charge control agent having positive chargeability or the charge control resin having positive chargeability also serves as an electron donating site, and hence a higher charge quantity is obtained.

Examples of the charge control agent having positive chargeability include a nigrosine dye, a quaternary ammonium salt, a triaminotriphenylmethane compound, and an imidazole compound.

Examples of the charge control resin having positive chargeability include a polyamine resin, a copolymer containing a quaternary ammonium group, and a copolymer containing a quaternary ammonium salt group. Of those, a charge control resin having satisfactory dispersibility in the toner is preferred, and a copolymer containing a quaternary ammonium salt group (e.g., a styrene acrylic resin containing a quaternary ammonium salt group) is more preferred.

In addition, the positive chargeability of the toner is easily affected by a surface of the toner particle, and hence it is preferred that the charge control agent or the charge control resin having positive chargeability be present on an outermost surface of the toner particle.

For example, in the toner having a core-shell structure, it is preferred that the charge control agent or the charge control resin having positive chargeability be contained in a shell agent.

The content of the charge control agent and/or the charge control resin to 100 parts by mass of the binder resin is preferably from 0.01 part by mass to 10 parts by mass, more preferably from 0.03 part by mass to 8 parts by mass. In addition, the charge control agents and the charge control resins may be used alone or in combination thereof.

### [External Addition Step]

In an external addition step, an external additive is caused to adhere to the surface of the toner base particle. As a result, a toner particle containing the toner base particle and the external additive adhering to a surface of the toner base particle is obtained. A method of causing the external additive to adhere to the surface of the toner base particle is not particularly limited, but is, for example, a method involving stirring the toner base particle and the external additive with a mixer.

<Method of separating and recovering Aluminum Oxide Particles in Toner>

160 g of sucrose (manufactured by Kishida Chemical Co., Ltd.) is added to 100 mL of ion-exchanged water and dissolved therein under heating with hot water to prepare a sucrose concentrate. 31 g of the sucrose concentrate and 6 mL of Contaminon N (10 mass % aqueous solution of a neutral detergent with a pH of 7 for cleaning a precision measurement instrument formed of a nonionic surfactant, an anionic surfactant, and an organic builder, manufactured by Wako Pure Chemical Industries, Ltd.) are placed in a centrifuge tube (volume: 50 ml). 1.0 g of toner is added to the mixture, and clumps of the toner are broken up with a spatula or the like. The centrifuge tube is shaken with a shaker (AS-1N, sold by AS ONE Corporation) at 300 strokes per min (spm) for 20 minutes. After the shaking, the solution is transferred to a glass tube (50 mL) for a swing rotor and separated in a centrifuge (H-9R, manufactured by KOKUSAN Co. Ltd.) at 3,500 rpm for 30 minutes.

Through the above-mentioned operation, toner particles and an external additive are separated. It is visually recognized that the toner particles and the aqueous solution are sufficiently separated, and the separated toner particles and external additive are collected with a spatula or the like. When inorganic fine particles A and the other external additive are mixed as the external additive, a resultant is isolated by being further subjected to centrifugal separation through use of differences in particle diameter and specific gravity to provide a target product. This operation is performed a plurality of times to secure a required amount. After the collected toner particles and aluminum oxide particles are filtered through a decompression filter and then dried with a dryer for 1 hour or more to provide a sample for measurement. This operation is performed a plurality of times to secure a required amount.

<Method of measuring Content of Aluminum Oxide Particles in Toner>

The content of aluminum oxide particles in the toner may be calculated by measuring toner and toner particles each having the external additive removed therefrom by the above-mentioned method with X-ray fluorescence analysis (XRF).

A wavelength-dispersive X-ray fluorescence analyzer “Axios” (manufactured by PANalytical) and the accompanying dedicated software “SuperQ ver. 4.0F” (manufactured by PANalytical) for setting measurement conditions and analyzing measurement data are used as a measurement device. Rh is used as an anode of an X-ray tube. A measurement atmosphere is set to a vacuum. A measurement diameter (collimator mask diameter) is set to 27 mm, and a measurement time is set to 10 seconds. In addition, when boron, which is a light element, is measured, boron is detected with a proportional counter (PC).

A pellet obtained by placing 4 g of toner in a dedicated aluminum ring for pressing, flattening the toner, and pressurizing the toner at 20 MPa for 60 seconds with a tablet forming compressor “BRE-32” (manufactured by Maekawa Testing Machine MFG, Co., LTD.) to a thickness of about 2 mm and a diameter of about 39 mm is used as a measurement sample, and counting rate intensity (unit: cps) of a Group 13 element is measured.

In this case, acceleration voltage and current value of an X-ray generating device are set to 32 kV and 125 mA, respectively.

### [Electrophotographic Apparatus]

The electrophotographic apparatus of the present invention includes: an electrophotographic photosensitive member; a charging unit that charges a surface of the electrophotographic photosensitive member; an exposing unit that irradiates the charged surface of the electrophotographic photosensitive member with light to form an electrostatic latent image on the surface of the electrophotographic photosensitive member; a developing unit, which includes toner, and which develops the electrostatic latent image formed on the surface of the electrophotographic photosensitive member with the toner to form a toner image on the surface of the electrophotographic photosensitive member; and a transfer unit that transfers the toner image from the surface of the electrophotographic photosensitive member to a transfer material.

The present invention is described below in detail based on an illustrated embodiment.

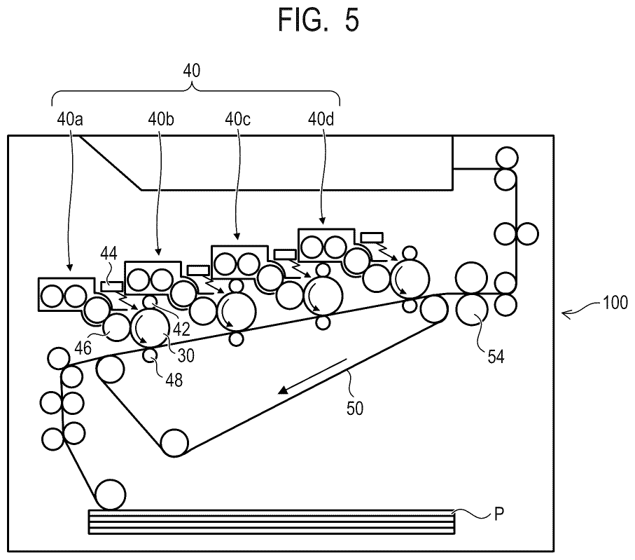

A tandem-type color electrophotographic apparatus is described below as an example with reference to FIG. 5. FIG. 5 is a sectional view for illustrating an example of an electrophotographic apparatus. An electrophotographic apparatus 100 illustrated in FIG. 5 includes image forming units 40a, 40b, 40c, and 40d, a transfer belt 50, and a fixing device 54. When distinction is not required, each of the image forming units 40a, 40b, 40c, and 40d is hereinafter sometimes referred to as “image forming unit 40.” The image forming unit 40 includes an image bearing member 30, a charging device 42, an exposing device 44, a developing device 46, and a transfer device 48. The image bearing member 30 is a photosensitive member (specifically, a monolayer type photosensitive member 1). In addition, a recording medium P is located in a lower portion of the electrophotographic apparatus. The image bearing member 30 is arranged at the center position of the imaging forming unit 40. The image bearing member 30 is arranged so as to be rotatable in the arrow direction (counterclockwise direction in FIG. 5). The charging device 42, the exposing device 44, the developing device 46, and the transfer device 48 are arranged on the periphery of the image bearing member 30 in the stated order from an upstream side in the rotation direction of the image bearing member 30.

Toner images of a plurality of colors (e.g., four colors of black, cyan, magenta, and yellow) are successively superimposed on the recording medium P on the transfer belt 50 by each of the image forming units 40a to 40d. The charging device 42 charges the surface (e.g., a peripheral surface) of the image bearing member 30 with positive polarity. When the image bearing member 30 is the monolayer type photosensitive member 1, the surface of the image bearing member 30 is charged with positive polarity. The charging device 42 is, for example, a charging roller. The exposing device 44 irradiates the charged surface of the image bearing member 30 with exposure light. That is, the exposing device 44 exposes the charged surface of the image bearing member 30 to light. As a result, an electrostatic latent image is formed on the surface of the image bearing member 30. The electrostatic latent image is formed based on image data input to the electrophotographic apparatus 100.

The developing device 46 supplies toner to the surface of the image bearing member 30, to thereby develop the electrostatic latent image as a toner image. The developing device 46 (e.g., the surface of the developing device 46, more specifically, the peripheral surface of the developing device 46) is in contact with the surface of the image bearing member 30. That is, the electrophotographic apparatus 100 adopts a contact developing system. The developing device 46 is, for example, a developing roller. When a developer is a one-component developer, the developing device 46 supplies toner that is a one-component developer to the electrostatic latent image formed on the image bearing member 30. When the developer is a two-component developer, the developing device 46 supplies toner among the toner and a carrier in the two-component developer to the electrostatic latent image formed on the image bearing member 30. In this manner, the image bearing member 30 bears the toner image. The transfer belt 50 conveys the recording medium P to the position between the image bearing member 30 and the transfer device 48.

The transfer belt 50 is an endless belt. The transfer belt 50 is arranged so as to be rotatable in the arrow direction (clockwise direction in FIG. 5). The transfer device 48 transfers the toner image developed by the developing device 46 from the surface of the image bearing member 30 to a transfer target member. The transfer target member is the recording medium P. When the toner image is transferred, the image bearing member 30 is in contact with the recording medium P. That is, the electrophotographic apparatus 100 adopts a direct transfer system. The transfer device 48 is, for example, a transfer roller. The recording medium P having the toner image transferred thereto by the transfer device 48 is conveyed to the fixing device 54 by the transfer belt 50. The fixing device 54 is, for example, a heating roller and/or a pressure roller. The unfixed toner image having been transferred by the transfer device 48 is heated and/or pressurized by the fixing device 54. The toner image is fixed to the recording medium P by being heated and/or pressurized. As a result, an image is formed on the recording medium P. An example of the electrophotographic apparatus has been described above, but the electrophotographic apparatus is not limited to the electrophotographic apparatus 100 described above. The electrophotographic apparatus 100 described above is a color electrophotographic apparatus, but the electrophotographic apparatus may also be a monochrome electrophotographic apparatus. In this case, it is only required that the electrophotographic apparatus include, for example, only one image forming unit.

In addition, the electrophotographic apparatus 100 described above adopts a tandem system, but the electrophotographic apparatus may also adopt, for example, a rotary system. The charging device 42 has been described by taking the charging roller as an example, but the charging device may be a charging device other than the charging roller (e.g., a scorotron charger, a charging brush, or a corotron charger). The electrophotographic apparatus 100 described above adopts a contact developing system, but the electrophotographic apparatus may also adopt a non-contact developing system. The electrophotographic apparatus 100 described above adopts a direct transfer system, but the electrophotographic apparatus may also adopt an intermediate transfer system. When the electrophotographic apparatus adopts an intermediate transfer system, the transfer target member corresponds to an intermediate transfer belt. In the electrophotographic apparatus, the image forming unit 40 described above does not include a cleaning member, but the image forming unit may further include a cleaning member (e.g., a cleaning blade). The image forming unit 40 described above does not include a charge eliminating device, but the image forming unit may further include a charge eliminating device.

### [Process Cartridge]

A process cartridge of the present invention is a process cartridge including: an electrophotographic photosensitive member; and a developing unit, which includes toner, and which is configured to form a toner image on a surface of the electrophotographic photosensitive member with the toner, the process cartridge integrally supporting the electrophotographic photosensitive member and the developing unit, and being detachably attachable onto a main body of an electrophotographic apparatus, wherein the electrophotographic photosensitive member includes a monolayer type photosensitive layer containing a charge generating material, a hole transporting material, an electron transporting material, and a binder resin, wherein the photosensitive layer contains, as the binder resin, a polyarylate resin having a structural unit represented by the following formula (1) and a structural unit represented by the following formula (2), wherein the toner is toner containing toner particles, wherein the toner particles each contain a toner base particle and an external additive adhering to a surface of the toner base particle, and wherein the external additive contains at least aluminum oxide particles.

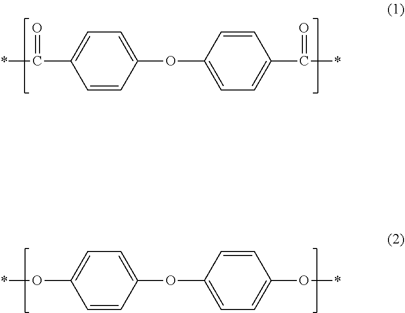

The electrophotographic photosensitive member and the toner are as described above, and hence the descriptions thereof are omitted.

Next, with continued reference to FIG. 5, an example of a process cartridge according to an embodiment of the present invention is described. The process cartridge corresponds to each of the image forming units 40a to 40d. The process cartridge includes the image bearing member 30. The image bearing member 30 is the photosensitive member of the first embodiment. The process cartridge further includes, in addition to the image bearing member 30, at least one selected from the group consisting of: the charging device 42, the exposing device 44, the developing device 46, and the transfer device 48. The process cartridge may further include a cleaning member (not shown) and a charge eliminating device (not shown). The process cartridge is designed so as to be detachably attachable onto the electrophotographic apparatus 100. Thus, the process cartridge is easy to handle and can be easily and quickly replaced together with the image bearing member 30 when the sensitivity characteristic, etc. of the image bearing member 30 deteriorate. The process cartridge including the photosensitive member has been described above with reference to FIG. 5.

### EXAMPLES

The present invention is described below in more detail by way of Examples and Comparative Examples. The present invention is by no means limited by the following Examples within a scope not departing from the gist of the present invention. In the following description of Examples, the term “part(s)” is by mass unless otherwise specified.

### <Production of Polyarylate Resin (PAR)>

### [Synthesis of Resin (PAR-1)]

A three-necked flask including a temperature gauge, a three-way cock, and a dropping funnel was used as a reaction vessel. The compound (BP-2) (41.0 mmol) serving as a monomer, 2,6-dimethylphenol (DMP) (0.213 mmol) serving as an end terminator, sodium hydroxide (98 mmol), and benzyltributylammonium chloride (0.384 mmol) were loaded into the reaction vessel. Air in the reaction vessel was replaced by an argon gas. Water (300 mL) was added to the contents of the reaction vessel. The contents of the reaction vessel were stirred at 50° C. for 1 hour. The contents of the reaction vessel were cooled to 10° C. to provide an alkaline aqueous solution A.

Next, a dicarboxylic acid dichloride (32.0 mmol) of the compound (DC-1) serving as a monomer was dissolved in chloroform (150 mL). As a result, a chloroform solution B was obtained.

The chloroform solution B was slowly dropped into the alkaline aqueous solution A over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, ion-exchanged water (400 mL) was loaded into an Erlenmeyer flask. The resultant organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with ion-exchanged water (1 L) through use of a separating funnel. The washing with ion-exchanged water was repeated five times. Thus, a water-washed organic layer was obtained. Next, the water-washed organic layer was filtered to provide filtrate. The resultant filtrate was slowly dropped into methanol (1 L) to provide a precipitate. The precipitate was taken out by filtration. The precipitate thus taken out was dried in a vacuum at a temperature of 70° C. for 12 hours. As a result, a resin (PAR-1) having a viscosity-average molecular weight of 35,000 was obtained.

### [Synthesis of Resin (PAR-2)]

A three-necked flask including a temperature gauge, a three-way cock, and a dropping funnel was used as a reaction vessel. The compound (BP-2) (28.7 mmol) serving as a monomer, the compound (BP-5) (12.3 mmol) serving as a monomer, 2,6-dimethylphenol (DMP) (0.413 mmol) serving as an end terminator, sodium hydroxide (98 mmol), and benzyltributylammonium chloride (0.384 mmol) were loaded into the reaction vessel. Air in the reaction vessel was replaced by an argon gas. Water (300 mL) was added to the contents of the reaction vessel. The contents of the reaction vessel were stirred at 50° C. for 1 hour. The contents of the reaction vessel were cooled to 10° C. to provide an alkaline aqueous solution A.

Next, a dicarboxylic acid dichloride (20.8 mmol) of the compound (DC-1) serving as a monomer, and a dicarboxylic acid dichloride (11.2 mmol) of the compound (DC-4) serving as a monomer were dissolved in chloroform (150 mL). As a result, a chloroform solution B was obtained.

The chloroform solution B was slowly dropped into the alkaline aqueous solution A over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, ion-exchanged water (400 mL) was loaded into an Erlenmeyer flask. The resultant organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with ion-exchanged water (1 L) through use of a separating funnel. The washing with ion-exchanged water was repeated five times. Thus, a water-washed organic layer was obtained. Next, the water-washed organic layer was filtered to provide filtrate. The resultant filtrate was slowly dropped into methanol (1 L) to provide a precipitate. The precipitate was taken out by filtration. The precipitate thus taken out was dried in a vacuum at a temperature of 70° C. for 12 hours. As a result, a resin (PAR-2) having a viscosity-average molecular weight of 55,000 was obtained.

### [Synthesis of Resins (PAR-3) to (PAR-14)]

Synthesis was performed by the same method as that in the synthesis of the resin (PAR-2) having a viscosity-average molecular weight of 55,000 except that the ratios of the bisphenol and the dicarboxylic acid, and the end terminator were changed. Thus, resins (PARs) having viscosity-average molecular weights shown in Table 1 were obtained. As the loading amount of the end terminator becomes smaller, the viscosity-average molecular weight of each of the resins (PARs) becomes higher.

TABLE 1

| | Bisphenol | | Dicarboxylic acid | | End | Molecular |
|---|---|---|---|---|---|---|
| Resin | BP-2 | BP-5 | DC-1 | DC-4 | terminator | weight |
| PAR-1 | 100 | — | 100 | — | DMP | 35,000 |
| PAR-2 | 70 | 30 | 70 | 30 | DMP | 55,000 |
| PAR-3 | 70 | 30 | 50 | 50 | DMP | 53,000 |
| PAR-4 | 70 | 30 | 55 | 45 | DMP | 66,000 |
| PAR-5 | 50 | 50 | 70 | 30 | DMP | 79,000 |
| PAR-6 | 50 | 50 | 50 | 50 | DMP | 61,000 |
| PAR-7 | 50 | 50 | 55 | 45 | DMP | 51,000 |
| PAR-8 | 20 | 80 | 70 | 30 | DMP | 56,000 |
| PAR-9 | 20 | 80 | 50 | 50 | DMP | 44,000 |
| PAR-10 | 20 | 80 | 55 | 45 | DMP | 67,000 |
| PAR-11 | 20 | 80 | 55 | 45 | PFH | 53,000 |
| PAR-12 | — | 100 | 50 | 50 | DMP | 55,000 |
| PAR-13 | 50 | 50 | — | 100 | DMP | 60,000 |
| PAR-14 | — | 100 | — | 100 | DMP | 68,000 |
| PAR-15 | 70 | 30 | 90 | 10 | DMP | 66,000 |
| PAR-16 | 70 | 30 | 80 | 20 | DMP | 65,000 |
| PAR-17 | 70 | 30 | 40 | 60 | DMP | 56,000 |
| PAR-18 | 50 | 50 | 90 | 10 | DMP | 60,000 |
| PAR-19 | 50 | 50 | 80 | 20 | DMP | 59,000 |
| PAR-20 | 50 | 50 | 40 | 60 | DMP | 54,000 |
| PAR-21 | 20 | 80 | 90 | 10 | DMP | 58,000 |
| PAR-22 | 20 | 80 | 80 | 20 | DMP | 67,000 |
| PAR-23 | 20 | 80 | 40 | 60 | DMP | 66,000 |

The numerical values of bisphenols in Table 1 each indicate a molar fraction of a bisphenol to a total of the moles of two kinds of bisphenols. In addition, the numerical values of dicarboxylic acids each indicate the molar fraction of a dicarboxylic acid to the total of the moles of two kinds of dicarboxylic acids. In addition, “PFH” represents 1H,1H-perfluoro-1-heptanol. In addition, the molecular weight indicates a viscosity-average molecular weight.

### <Production of Electrophotographic Photosensitive Member>

### [Production of Photosensitive Member 1]

2.0 Parts by mass of the Y-form titanyl phthalocyanine (CGM-1) serving as a charge generating material, 70.0 parts by mass of the hole transporting material (H-11), 50.0 parts by mass of the electron transporting material (E-4), 100.0 parts by mass of the polyarylate resin (PAR-1) serving as a binder resin, 14.0 parts by mass of the additive (T-1), and 500.0 parts by mass of tetrahydrofuran serving as a solvent were mixed with a rod-shaped sonic oscillator for 20 minutes to provide a dispersion liquid. The dispersion liquid was filtered through a filter having an opening of 5 μm to provide a coating liquid for a photosensitive layer. The coating liquid for a photosensitive layer was applied onto an electroconductive base (drum-shaped support made of aluminum) by a dip coating method, and was dried with hot air at 120° C. for 50 minutes. Thus, a photosensitive layer (thickness: 30 μm) was formed on the electroconductive base to provide a photosensitive member 1.

### (Resin Component Analysis of Photosensitive Member 1)

A ¹H-NMR spectrum was obtained by ¹H-nuclear magnetic resonance spectrometry of polymer components recovered from a resultant photosensitive member in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, and 7.04±0.02 ppm. Thus, it was specified that the photosensitive member had the structural units represented by the formulae (1) and (2). In addition, a ratio between substance amounts of the formula (1) and the formula (2) was 1:1 as shown in Table 1 based on integration ratios of the above-mentioned peaks.

### [Production of Photosensitive Members 2 to 32]

Photosensitive members 2 to 32 were each produced by a same method as that in the production of the photosensitive member 1 except that different kinds of the charge generating material, the additive, the hole transporting material, the electron transporting material, and the binder resin were used. Kinds of the charge generating material, the additive, the hole transporting material, the electron transporting material, and the binder resin used are shown in Table 2. In addition, a ratio of each mass is not changed for each photosensitive member. Production examples of the photosensitive members are shown in Table 2. A thickness of a photosensitive layer in the photosensitive member 5 was 50 μm. In addition, the thickness of a photosensitive layer in each of the other photosensitive members 2 to 4 and 6 to 32 was 30 μm. In Table 2, “CGM” represents a charge generating material, “HTM” represents a hole transporting material, and “ETM” represents an electron transporting material.

### (Resin Component Analysis of Photosensitive Member 8)

A ¹H-NMR spectrum was obtained by ¹H-nuclear magnetic resonance spectrometry of polymer components recovered from a resultant photosensitive member in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. Thus, it was specified that the photosensitive member had the structural units represented by the formula (1), (2), (4), and (5). In addition, the ratios of the substance amounts of the formula (1), the formula (2), the formula (4), and the formula (5) were as shown in Table 1 based on the integration ratios of the above-mentioned peaks.

### [Production of Photosensitive Member 33]

A photosensitive member 33 was produced by a same method as that of the photosensitive member 8 except that 60 parts by mass of (PAR-08) and 40 parts by mass of (PAR-14) were used as the polyarylate resin serving as a binder resin.

### [Production of Photosensitive Member 34]

A photosensitive member 34 was produced by a same method as that of the photosensitive member 8 except that 40 parts by mass of (PAR-08) and 60 parts by mass of (PAR-14) were used as the polyarylate resin serving as a binder resin.

TABLE 2

| | PAR | | | | Addi- |
|---|---|---|---|---|---|
| | resin | CGM | HTM | ETM | tive |
| Photosensitive member-1 | PAR-1 | CGM-1 | H-11 | E-4 | T-1 |
| Photosensitive member-2 | PAR-2 | CGM-1 | H-11 | E-4 | T-1 |
| Photosensitive member-3 | PAR-3 | CGM-1 | H-11 | E-4 | T-1 |
| Photosensitive member-4 | PAR-4 | CGM-1 | H-11 | E-4 | T-1 |
| Photosensitive member-5 | PAR-5 | CGM-1 | H-11 | E-4 | T-1 |
| Photosensitive member-6 | PAR-6 | CGM-1 | H-11 | E-4 | T-1 |
| Photosensitive member-7 | PAR-7 | CGM-1 | H-11 | E-4 | T-1 |
| Photosensitive member-8 | PAR-8 | CGM-1 | H-11 | E-4 | T-1 |
| Photosensitive member-9 | PAR-9 | CGM-1 | H-11 | E-4 | T-1 |
| Photosensitive member-10 | PAR-10 | CGM-1 | H-11 | E-4 | T-1 |
| Photosensitive member-11 | PAR-11 | CGM-1 | H-11 | E-4 | T-1 |
| Photosensitive member-12 | PAR-8 | CGM-1 | H-11 | E-4 | — |
| Photosensitive member-13 | PAR-8 | CGM-1 | H-1 | E-4 | T-1 |
| Photosensitive member-14 | PAR-8 | CGM-1 | H-5 | E-4 | T-1 |
| Photosensitive member-15 | PAR-8 | CGM-1 | H-9 | E-4 | T-1 |
| Photosensitive member-16 | PAR-8 | CGM-1 | H-10 | E-4 | T-1 |
| Photosensitive member-17 | PAR-8 | CGM-1 | H-11 | E-1 | T-1 |
| Photosensitive member-18 | PAR-8 | CGM-1 | H-11 | E-2 | T-1 |
| Photosensitive member-19 | PAR-8 | CGM-1 | H-11 | E-7 | T-1 |
| Photosensitive member-20 | PAR-8 | CGM-1 | H-11 | E-8 | T-1 |
| Photosensitive member-21 | PAR-12 | CGM-1 | H-11 | E-4 | T-1 |
| Photosensitive member-22 | PAR-13 | CGM-1 | H-11 | E-4 | T-1 |
| Photosensitive member-23 | PAR-14 | CGM-1 | H-11 | E-4 | T-1 |
| Photosensitive member-24 | PAR-15 | CGM-1 | H-11 | E-4 | T-1 |
| Photosensitive member-25 | PAR-16 | CGM-1 | H-11 | E-4 | T-1 |
| Photosensitive member-26 | PAR-17 | CGM-1 | H-11 | E-4 | T-1 |
| Photosensitive member-27 | PAR-18 | CGM-1 | H-11 | E-4 | T-1 |
| Photosensitive member-28 | PAR-19 | CGM-1 | H-11 | E-4 | T-1 |
| Photosensitive member-29 | PAR-20 | CGM-1 | H-11 | E-4 | T-1 |
| Photosensitive member-30 | PAR-21 | CGM-1 | H-11 | E-4 | T-1 |
| Photosensitive member-31 | PAR-22 | CGM-1 | H-11 | E-4 | T-1 |
| Photosensitive member-32 | PAR-23 | CGM-1 | H-11 | E-4 | T-1 |
| Photosensitive member-33 | PAR-8 | CGM-1 | H-11 | E-4 | T-1 |
| | PAR-14 | | | | |
| Photosensitive member-34 | PAR-8 | CGM-1 | H-11 | E-4 | T-1 |
| | PAR-14 | | | | |

### Production Example of Toner

### <Preparation of Polymer A0>

The following materials were loaded into a reaction vessel including a reflux condenser, a stirrer, a temperature gauge, and a nitrogen inlet tube under a nitrogen atmosphere.

| | |
|---|---|
| Toluene | 100.0 parts |
| Monomer composition | 100.0 parts |

(monomer composition obtained by mixing behenyl acrylate, methacrylonitrile, and styrene described below at ratios shown below)

| | | |
|---|---|---|
| Behenyl acrylate (first polymerizable | 67.0 | parts (28.9 mol %) |
| monomer) | | |
| Methacrylonitrile (second polymerizable | 22.0 | parts (53.8 mol %) |
| monomer) | | |
| Styrene (third polymerizable monomer) | 11.0 | parts (17.3 mol %) |
| t-Butyl peroxypivalate | 0.5 | part |

(polymerization initiator, manufactured by NOF Corporation: PERBUTYL PV)

The materials in the reaction vessel were heated to 70° C. to allow a polymerization reaction to proceed for 12 hours while being stirred at 200 rpm. Thus, a solution in which a polymer of the monomer composition was dissolved in toluene was obtained. Subsequently, the solution was decreased in temperature to 25° C., and then the solution was loaded into 1,000.0 parts of methanol while being stirred. Thus, a methanol-insoluble content was precipitated. A resultant methanol-insoluble content was separated by filtration. The resultant was further washed with methanol, and was then dried in a vacuum at 40° C. for 24 hours to provide a polymer A0. The polymer A0 had a weight-average molecular weight (Mw) of 68,400, an acid value of 0.0 mgKOH/g, and a melting point of 62° C.

As a result of the analysis of the polymer A0 by NMR, the polymer was found to contain 28.9 mol % of a monomer unit derived from behenyl acrylate, 53.8 mol % of a monomer unit derived from methacrylonitrile, and 17.3 mol % of a monomer unit derived from styrene.

### <Preparation of Amorphous Resin>

The following raw materials were loaded into a two-necked flask dried by heating while nitrogen was introduced thereto.

| | | |
|---|---|---|
| Polyoxypropylene(2.2)-2,2-bis(4-hydroxyphenyl)propane | 30.0 | parts |
| Polyoxyethylene(2.2)-2,2-bis(4-hydroxyphenyl)propane | 33.0 | parts |
| Terephthalic acid | 21.0 | parts |
| Dodecenylsuccinic acid | 15.0 | parts |
| Dibutyltin oxide | 0.1 | part |

The inside of the system was replaced by nitrogen through a decompression operation, followed by stirring at 215° C. for 5 hours. After that, a temperature in the system was gradually increased to 230° C. under reduced pressure with continued stirring and further kept for 2 hours. When a mixture was brought into viscous, the reaction was terminated by air cooling. Thus, an amorphous resin that was amorphous polyester was synthesized. The amorphous resin had a number-average molecular weight (Mn) of 5,200, a weight-average molecular weight (Mw) of 23,000, and a glass transition temperature (Tg) of 55° C.

### [Production of Toner by Suspension Polymerization Method]

### (Production of Toner Base Particle 1)

Monomer composition 100.0 parts
(monomer composition obtained by mixing behenyl acrylate, methacrylonitrile, styrene, and a macromonomer described below at ratios shown below)

| | | |
|---|---|---|
| Behenyl acrylate (first polymerizable monomer) | 66.8 | parts (28.87 mol %) |
| Methacrylonitrile (second polymerizable monomer) | 21.9 | parts (53.79 mol %) |
| Styrene | 11.0 | parts (17.33 mol %) |
| Polymethyl methacrylate having a methacryloyl | 0.3 | part (8.2 × 10⁻³ mol %) |
| group at a terminal thereof (macromonomer, | | |
| manufactured by Toagosei Co., Ltd., AA-6, | | |
| Mn: 6,000) | | |
| Pigment Blue 15:3 | 6.5 | parts |
| Charge control resin | 0.7 | part |
| (quaternary ammonium salt-containing styrene- | | |
| acrylic acid-based resin, “FCA-201-PS” | | |
| manufactured by Fujikura Kasei Co., Ltd.) | | |
| Release agent | 20.0 | parts |
| (product name: HNP-51, melting point: 78° C., | | |
| manufactured by Nippon Seiro Co., Ltd.) | | |
| Toluene | 100.0 | parts |

A mixture formed of the above-mentioned materials was prepared. The mixture was loaded into an attritor (manufactured by Nippon Coke & Engineering. Co., Ltd.), and was dispersed with zirconia beads each having a diameter of 5 mm at 200 rpm for 2 hours to provide a raw material dispersion liquid.

Meanwhile, an aqueous solution obtained by dissolving 6.2 parts of sodium hydroxide (alkali metal hydroxide) in 50 parts of ion-exchanged water was gradually added under stirring to an aqueous solution obtained by dissolving 10.2 parts of magnesium chloride (water-soluble polyvalent metal salt) in 250 parts of ion-exchanged water at room temperature to prepare a magnesium hydroxide colloid (poorly water-soluble metal hydroxide colloid) dispersion liquid.

The above-mentioned polymerizable monomer composition was loaded into the magnesium hydroxide colloid dispersion liquid at room temperature, followed by stirring. 8.0 Parts of t-butyl peroxypivalate (PERBUTYL PV, manufactured by NOF corporation) was loaded into a resultant as a polymerization initiator, and then dispersion was performed by high-speed shearing and stirring at a rotation speed of 15,000 rpm for 10 minutes with an in-line emulsion disperser (product name: MILDER, manufactured by Pacific Machinery & Engineering Co., Ltd.). Thus, liquid droplets of the polymerizable monomer composition were formed.

A resultant granulation liquid was transferred to a reaction vessel including a reflux condenser, a stirrer, a temperature gauge, and a nitrogen inlet tube, and the granulation liquid was increased in temperature to 70° C. while being stirred at 150 rpm under a nitrogen atmosphere. A polymerization reaction was performed at 150 rpm for 10 hours while the temperature was kept at 70° C. After that, the reflux condenser was removed from the reaction vessel, and the reaction liquid was increased in temperature to 95° C. Then, toluene was removed by stirring the reaction liquid at 150 rpm for 5 hours while the temperature was kept at 95° C. Thus, a toner baser particle dispersion liquid was obtained.

While the obtained toner base particle dispersion liquid was stirred at room temperature, sulfuric acid was dropped thereinto, and acid washing was performed until the pH of the liquid reached 6.5 or less. Then, filtration separation was performed, and a resultant solid content was re-slurried by adding 500 parts of ion-exchanged water thereto. Water washing treatment (washing, filtration, and dehydration) was repeated several times. Then, filtration separation was performed, and the resultant solid content was placed in a container of a dryer, and was dried at 40° C. for 24 hours to provide toner base particles 1 each containing a polymer A1 of the monomer composition.

In addition, a polymer A1′ was obtained in the same manner as described above except that Pigment Blue 15:3, the charge control resin, and the release agent were not used in the above-mentioned production method for the toner base particles 1.

The polymer A1′ had a weight-average molecular weight (Mw) of 57,000 and a melting point of 62° C.

As a result of the analysis of the polymer A1 by NMR, the polymer was found to contain 28.87 mol % of a monomer unit derived from behenyl acrylate, 53.79 mol % of a monomer unit derived from methacrylonitrile, 17.33 mol % of a monomer unit derived from styrene, and 8.2×10⁻³ mol % of the macromonomer.

The polymer A1 and the polymer A1′ were produced in a same manner, and were hence determined to have equivalent physical properties.

### (Preparation of Toner 1)

The toner base particles 1 were subjected to external addition. 0.7 Part of alumina particles 1 (alumina particles obtained by firing aluminum hydroxide and then pulverizing the resultant with a pulverizer, number-average particle diameter: 150 nm) and 1.0 part of silica fine particles (silica fine particles in which the number-average particle diameter of primary particles subjected to hydrophobization treatment with an amino-modified silicone oil was 55 nm) were dry-mixed with 100.0 parts of the toner base particles 1 through use of a Henschel mixer (manufactured by Mitsui Mining Co., Ltd.) for 5 minutes to provide a toner 1 (TA-1) containing toner particles 1.

### Production Example of Toner 2

A toner 2 (TA-2) was obtained in a same manner as in the toner 1 described above except that the alumina particles 1 were changed to alumina particles 2 (alumina particles obtained by firing aluminum hydroxide and then pulverizing a resultant with a pulverizer, number-average particle diameter: 250 nm).

### Production Example of Toner 3

A toner 3 (TA-3) was obtained in a same manner as in the toner 1 described above except that the alumina particles 1 were changed to alumina particles 3 (alumina particles obtained by firing aluminum hydroxide and then pulverizing the resultant with a pulverizer, number-average particle diameter: 450 nm).

### Production Example of Toner 4

### [Production of Toner by Pulverization Method]

| | | |
|---|---|---|
| Polymer A0 | 100.0 | parts |
| C.I. Pigment Blue 15:3 | 6.5 | parts |
| Release agent (HNP-51, melting point: 78° C., | 2.0 | parts |
| manufactured by Nippon Seiro Co., Ltd.) | | |
| Charge control agent | 1.5 | parts |
| (quaternary ammonium salt, manufactured by | | |
| Orient Chemical Industries Co., Ltd. | | |
| “BONTRON P-51”) | | |

The above-mentioned materials were pre-mixed with an FM mixer (manufactured by Nippon Coke & Engineering Co., Ltd.), and then the mixture was subjected to melt-kneading with a twin-screw kneading extruder (Model PCM-30, manufactured by Ikegai Ironworks Corp.)

A resultant kneaded product was cooled and coarsely pulverized with a hammer mill and was then pulverized with a mechanical pulverizer (T-250, manufactured by Turbo Kogyo Co., Ltd.). A resultant fine pulverized powder was classified with a multi-stage classifier using a Coanda effect to provide toner core particles having a weight-average particle diameter (D4) of 7.0 μm.

Meanwhile, 300 mL of ion-exchanged water was placed in a 1 L-volume three-necked flask including a temperature gauge and a stirring blade, and then a temperature in the flask was kept at 30° C. with a water bath. Then, dilute hydrochloric acid was added to the flask to adjust the pH of the aqueous medium in the flask to 4. After the pH adjustment, 2 mL of an aqueous solution of an initial polymer of hexamethylol melamine (“Mirbane Resin SM-607”, manufactured by Showa Denko K.K., solid content concentration: 80 mass %) was added to the flask as a raw material for a shell layer. Then, the contents of the flask were stirred so that the raw material for a shell layer was dissolved in the aqueous medium. Thus, an aqueous solution of the raw material for a shell layer was obtained.

300 g of the above-mentioned toner core particles were added to the three-necked flask containing the above-mentioned aqueous solution, and contents of the flask were stirred at a speed of 200 rpm for 1 hour. Then, 300 mL of ion-exchanged water was added thereto, and a temperature in the flask was increased to 70° C. at a rate of 1° C./min with stirring at 100 rpm. After the temperature increase, the contents of the flask were continuously stirred at 70° C. and 100 rpm for 2 hours. After that, the pH of the contents of the flask was adjusted to 7 by adding sodium hydroxide. Then, the contents of the flask were cooled to normal temperature to provide a dispersion liquid containing toner base particles.

Wet cake-like toner base particles were filtered out from the dispersion liquid containing toner base particles with a Buchner funnel. The wet cake-like toner base particles were washed by dispersing the toner base particles in ion-exchanged water. Then, the toner base particles were dried by hot air drying to provide toner particles 4. The toner particles 4 were subjected to a same external addition as that in the production example of the toner 1 to provide a toner 4 (TA-4).

### Production Example of Toner 5

A toner 5 (TA-5) was obtained in a same manner as in the toner 1 described above except that an amount of the alumina particles 1 was changed to 0.1 part.

### Production Example of Toner 6

A toner 6 (TA-6) was obtained in a same manner as in the toner 1 described above except that an amount of the alumina particles 1 was changed to 3.0 parts.

### Production Example of Toner 7

A toner 7 (TA-7) was obtained in a same manner as in the toner 1 described above except that the alumina particles 1 were changed to alumina particles 4 (alumina particles obtained by firing aluminum hydroxide and then pulverizing the resultant with a pulverizer, number-average particle diameter: 60 nm).

### Production Example of Toner 8

A toner 8 (TA-8) was obtained in a same manner as in the toner 1 described above except that 0.3 part of commercially available strontium titanate (manufactured by Titan Kogyo, Ltd., number-average particle diameter: 110 nm) was further added as an external additive.

### Production Example of Toner 9

A toner 9 (TA-9) was obtained in a same manner as in the toner 8 described above except that 0.5 part of polytetrafluoroethylene (L170JE manufactured by AGC Inc.) was further added as an external additive.

### <Evaluation>

Photosensitive members (monolayer type photosensitive members) and toners were each evaluated for positive chargeability by methods described below. The photosensitive member was mounted on an evaluation machine. A modified machine of an electrophotographic apparatus (“MFC-9840-CDW” manufactured by Brother Industries, Ltd.) was used as the evaluation machine.

### [Evaluation of Positive Chargeability]

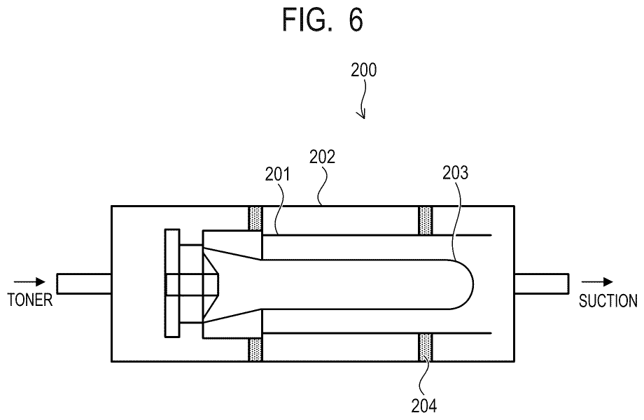

The toner on the photosensitive member was suctioned and collected with a metal cylindrical tube and a cylindrical filter, and triboelectric charge quantity of the toner and a toner laid-on level were calculated. Specifically, the triboelectric charge quantity of the toner and the toner laid-on level on the photosensitive member were measured with a Faraday-Cage as illustrated in FIG. 6.

Through use of a Faraday-Cage 200 including an inner cylinder 201 and an outer cylinder 202 that are inner and outer double cylinders in which metal cylinders having different shaft diameters are arranged so as to be coaxial with each other, and further including a filter 203 for taking the toner in the inner cylinder 201, the toner on the photosensitive member is suctioned with air. In the Faraday-Cage 200, the inner cylinder 201 and the outer cylinder 202 are insulated from each other by an insulating member 204. When the toner is taken into the filter, electrostatic induction is caused by the charge quantity Q of the toner. When a charged body having the charge quantity Q is placed in the inner cylinder, the situation becomes as if a metal cylinder having the charge quantity Q exists through electrostatic induction. This induced charge quantity was measured with an electrometer (Keithley 6517A manufactured by Keithley Instruments, Inc.), and a charge quantity per unit mass (Q/M) obtained by dividing the charge quantity Q (mC) by a toner mass M (kg) in the inner cylinder was used as the triboelectric charge quantity of the toner.

In addition, a toner laid-on level per unit area was determined by measuring a suctioned area S (cm²) and dividing the toner mass M by the suctioned area S (cm²).

In the above-mentioned electrophotographic apparatus, a rotation of the photosensitive member was stopped before the toner layer formed on the photosensitive member was transferred onto an intermediate transfer member, and a measurement was performed by directly suctioning the toner image on the photosensitive member with air.

$$Toner laid - on level ( mg / {cm}^{2} ) = M / S$$

$$Triboelectric charge quantity of toner ( mC / kg ) = Q / M$$

In the above-mentioned electrophotographic apparatus, the toner laid-on level on the photosensitive member was adjusted to 0.35 mg/cm², and the toner was suctioned and collected with the above-mentioned metal cylindrical tube and cylindrical filter. Then, the charge quantity Q stored in a capacitor through the metal cylindrical tube and the mass M of the collected toner were measured, and the charge quantity per unit mass Q/M (mC/kg) was calculated to determine the charge quantity per unit mass Q/M (mC/kg) on the photosensitive member. The charge quantity per unit mass was adopted as a toner charge quantity, which was a value for evaluating the positive chargeability.

The evaluation results are shown in Table 3.

TABLE 3

| | | | Toner charge |
|---|---|---|---|
| | | | quantity Q/M |
| | Toner | Photosensitive member | [mC/Kg] |
| Example 1 | TA-1 | Photosensitive member 1 | 41.8 |
| Example 2 | TA-1 | Photosensitive member 2 | 43.6 |
| Example 3 | TA-1 | Photosensitive member 3 | 41.8 |
| Example 4 | TA-1 | Photosensitive member 4 | 42.6 |
| Example 5 | TA-1 | Photosensitive member 5 | 43.4 |
| Example 6 | TA-1 | Photosensitive member 6 | 42.5 |
| Example 7 | TA-1 | Photosensitive member 7 | 42.7 |
| Example 8 | TA-1 | Photosensitive member 8 | 44.5 |
| Example 9 | TA-1 | Photosensitive member 9 | 42.5 |
| Example 10 | TA-1 | Photosensitive member 10 | 42.9 |
| Example 11 | TA-1 | Photosensitive member 11 | 41.6 |
| Example 12 | TA-2 | Photosensitive member 8 | 43.6 |
| Example 13 | TA-3 | Photosensitive member 8 | 43.8 |
| Example 14 | TA-4 | Photosensitive member 8 | 45.2 |
| Example 15 | TA-5 | Photosensitive member 8 | 41.5 |
| Example 16 | TA-6 | Photosensitive member 8 | 42.8 |
| Example 17 | TA-7 | Photosensitive member 8 | 42.5 |
| Example 18 | TA-8 | Photosensitive member 8 | 45.5 |
| Example 19 | TA-9 | Photosensitive member 8 | 45.6 |
| Example 20 | TA-1 | Photosensitive member 24 | 44.1 |
| Example 21 | TA-1 | Photosensitive member 25 | 43.9 |
| Example 22 | TA-1 | Photosensitive member 26 | 40.9 |
| Example 23 | TA-1 | Photosensitive member 27 | 44.2 |
| Example 24 | TA-1 | Photosensitive member 28 | 44.0 |
| Example 25 | TA-1 | Photosensitive member 29 | 41.3 |
| Example 26 | TA-1 | Photosensitive member 30 | 44.9 |
| Example 27 | TA-1 | Photosensitive member 31 | 44.7 |
| Example 28 | TA-1 | Photosensitive member 32 | 41.5 |
| Example 29 | TA-1 | Photosensitive member 33 | 40.8 |
| Example 30 | TA-1 | Photosensitive member 34 | 40.1 |
| Comparative | TA-1 | Photosensitive member 21 | 35.5 |
| Example 1 | | | |
| Comparative | TA-1 | Photosensitive member 22 | 36.4 |
| Example 2 | | | |
| Comparative | TA-1 | Photosensitive member 23 | 33.5 |
| Example 3 | | | |
| Comparative | TA-4 | Photosensitive member 21 | 37.1 |
| Example 4 | | | |
| Comparative | TA-4 | Photosensitive member 22 | 37.5 |
| Example 5 | | | |
| Comparative | TA-4 | Photosensitive member 23 | 35.2 |
| Example 6 | | | |

In each of Examples 1 to 19 using the photosensitive member containing the polyarylate resin, and the toner according to the present invention, a decrease in toner charge quantity was suppressed.

Meanwhile, the toner charge quantity was decreased in each of Comparative Examples.

According to the present invention, a highly durable electrophotographic apparatus excellent in positive chargeability can be provided in an electrophotographic apparatus that uses alumina as a toner external additive.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-187006, filed Oct. 31, 2023, and Japanese Patent Application No. 2024-174050, filed Oct. 3, 2024, which are hereby incorporated by reference herein in their entirety.

1. An electrophotographic apparatus comprising:
an electrophotographic photosensitive member;
a charging unit configured to charge a surface of the electrophotographic photosensitive member;
an exposing unit configured to irradiate the charged surface of the electrophotographic photosensitive member with light to form an electrostatic latent image on the surface of the electrophotographic photosensitive member;
a developing unit, which includes toner, and which is configured to develop the electrostatic latent image formed on the surface of the electrophotographic photosensitive member with the toner to form a toner image on the surface of the electrophotographic photosensitive member; and
a transfer unit configured to transfer the toner image from the surface of the electrophotographic photosensitive member onto a transfer material,
wherein the electrophotographic photosensitive member includes a monolayer type photosensitive layer containing a charge generating material, a hole transporting material, an electron transporting material, and a binder resin,
wherein the photosensitive layer contains a polyarylate resin having a structural unit represented by the following formula (1) and a structural unit represented by the following formula (2) as the binder resin,
wherein the toner is toner containing toner particles,
wherein the toner particles each contain a toner base particle and an external additive adhering to a surface of the toner base particle, and
wherein the external additive contains at least aluminum oxide particles.

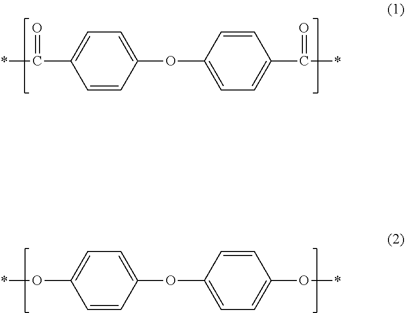

2. The electrophotographic apparatus according to claim 1, wherein the photosensitive layer further contains a polyarylate resin having a structural unit represented by the following formula (3) and a structural unit represented by the following formula (4) as the binder resin.

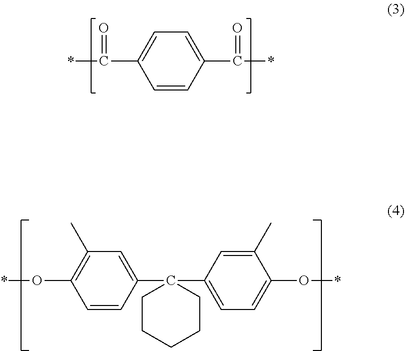

3. The electrophotographic apparatus according to claim 1, wherein a ratio of a molar number of the structural unit represented by the formula (1) to a total of molar numbers of structural units derived from dicarboxylic acids for forming the polyarylate resin is 0.50 or more.

4. The electrophotographic apparatus according to claim 2,
wherein the polyarylate resin has the structural unit represented by the formula (1), the structural unit represented by the formula (2), the structural unit represented by the formula (3), and the structural unit represented by the formula (4), and
wherein when a molar number of the structural unit represented by the formula (1) in a total amount of the molar number of the structural unit represented by the formula (1) and a molar number of the structural unit represented by the formula (3) is represented by M1, a molar number of the structural unit represented by the formula (2) in a total amount of the molar number of the structural unit represented by the formula (2) and a molar number of the structural unit represented by the formula (4) is represented by M2, the molar number of the structural unit represented by the formula (3) in the total amount of the molar number of the structural unit represented by the formula (1) and the molar number of the structural unit represented by the formula (3) is represented by M3, and the molar number of the structural unit represented by the formula (4) in the total amount of the molar number of the structural unit represented by the formula (2) and the molar number of the structural unit represented by the formula (4) is represented by M4, 0.30≤M3/(M1+M3)<0.7 and 0<M2/(M2+M4)<0.5 are satisfied.

5. The electrophotographic apparatus according to claim 1, wherein a ratio of a mass of the polyarylate resin is 50 mass % or more with respect to a mass of the binder resin.

6. The electrophotographic apparatus according to claim 1,
wherein the toner base particles each contain a binder resin, and
wherein the aluminum oxide particles serving as the external additive to 100 parts by mass of the toner base particles are 0.1 part by mass or more and 3.0 parts by mass or less.

7. The electrophotographic apparatus according to claim 1, wherein the aluminum oxide particles have a number-average value of long diameters of 60 nm or more and 450 nm or less.

8. The electrophotographic apparatus according to claim 1, wherein the external additive contains strontium titanate particles.

9. The electrophotographic apparatus according to claim 1, wherein the external additive contains fluorine-based resin particles.

10. The electrophotographic apparatus according to claim 1, wherein the electron transporting material contains a compound represented by the following formula (10), a compound represented by the following formula (11), a compound represented by the following formula (12), a compound represented by the following formula (13), a compound represented by the following formula (14), a compound represented by the following formula (15), or a compound represented by the following formula (16): 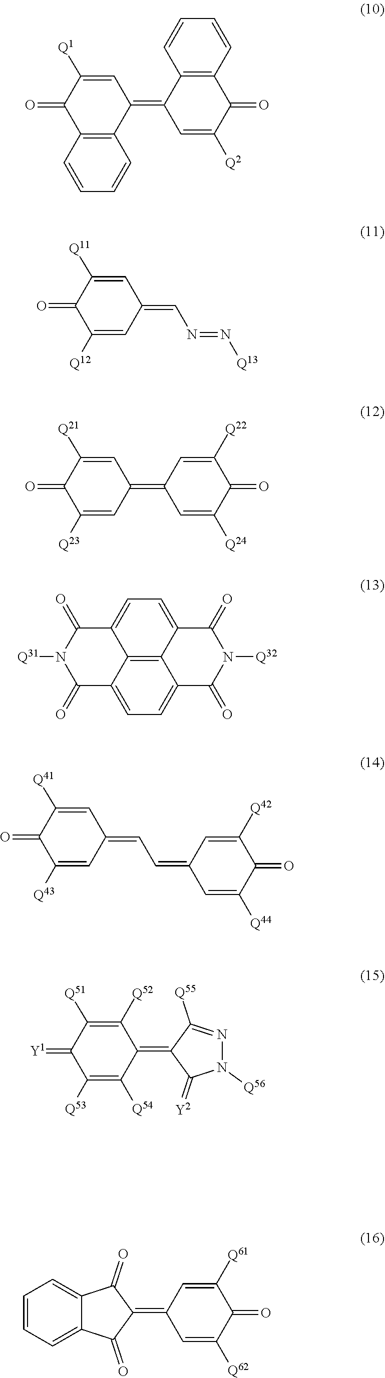
where Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom, and Y¹ and Y² in the formula (15) each independently represent an oxygen atom or a sulfur atom.

11. The electrophotographic apparatus according to claim 1, wherein the electron transporting material contains a compound represented by the following formula (E-1), a compound represented by the following formula (E-2), a compound represented by the following formula (E-3), a compound represented by the following formula (E-4), a compound represented by the following formula (E-5), a compound represented by the following formula (E-6), a compound represented by the following formula (E-7), or a compound represented by the following formula (E-8).

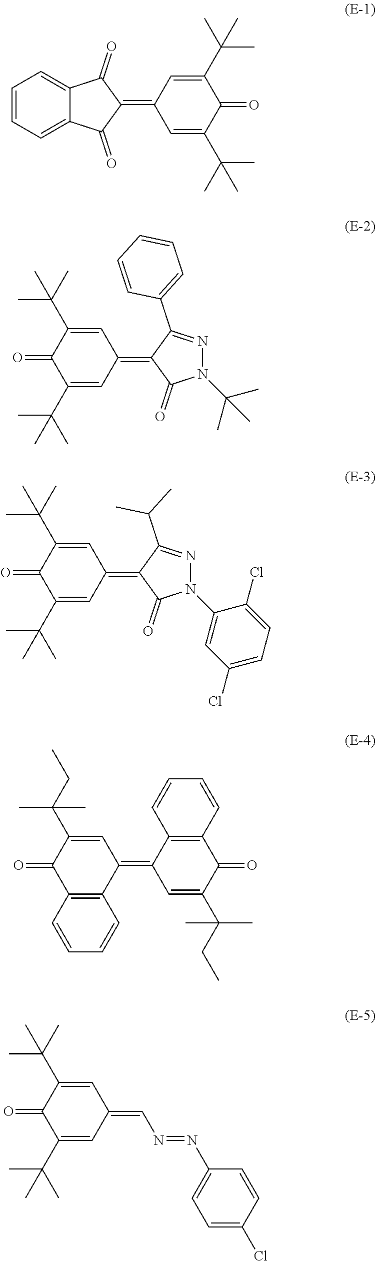

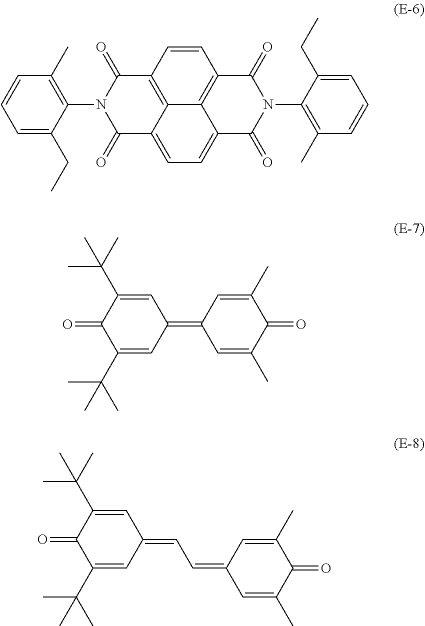

12. The electrophotographic apparatus according to claim 1, wherein the hole transporting material contains a compound represented by the following formula (20), a compound represented by the following formula (21), a compound represented by the following formula (22), a compound represented by the following formula (23), or a compound represented by the following formula (24): 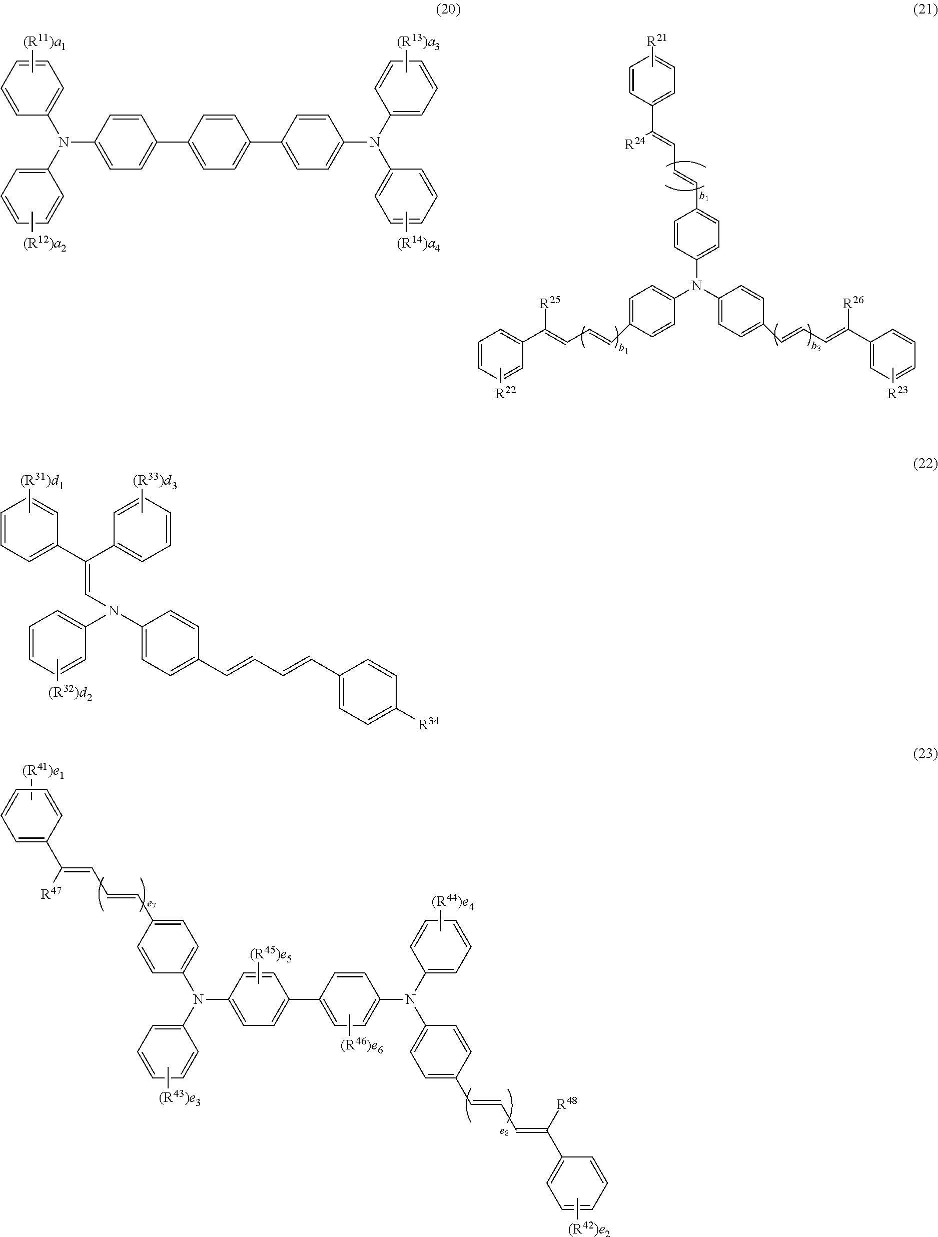 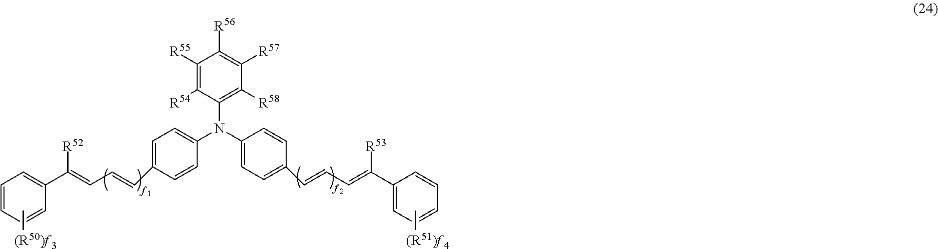
in the formula (20), R¹¹, R¹², R¹³, and R¹⁴ each independently represent an alkyl group having 1 or more and 6 or less carbon atoms, or an alkoxy group having 1 or more and 6 or less carbon atoms, and a¹, a², a³, and a⁴ each independently represent an integer of 0 or more and 5 or less; in the formula (21), R²¹, R²², and R²³ each independently represent an alkyl group having 1 or more and 6 or less carbon atoms, R²⁴, R²⁵, and R²⁶ each independently represent a hydrogen atom, or an alkyl group having 1 or more and 6 or less carbon atoms, and b¹, b², and b³ each independently represent 0 or 1; in the formula (22), R³¹, R³², and R³³ each independently represent an alkyl group having 1 or more and 6 or less carbon atoms, R³⁴ represents an alkyl group having 1 or more and 6 or less carbon atoms, or a hydrogen atom, and d¹, d², and d³ each independently represent an integer of 0 or more and 5 or less; in the formula (23), R⁴¹, R⁴², R⁴³, R⁴⁴, R⁴⁵, and R⁴⁶ each independently represent an alkyl group having 1 or more and 6 or less carbon atoms, or a phenyl group, R⁴⁷ and R⁴⁸ each independently represent a hydrogen atom, an alkyl group having 1 or more and 6 or less carbon atoms, or a phenyl group, e¹, e², e³, and e⁴ each independently represent an integer of 0 or more and 5 or less, e⁵ and e⁶ each independently represent an integer of 0 or more and 4 or less, and e⁷ and e⁸ each independently represent 0 or 1; and in the formula (24), R⁵⁰ and R⁵¹ each independently represent an alkyl group having 1 or more and 6 or less carbon atoms, an alkoxy group having 1 or more and 6 or less carbon atoms, or a phenyl group, R⁵², R⁵³, R⁵⁴, R⁵⁵, R⁵⁶, R⁵⁷, and R⁵⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms, f¹ and f² each independently represent an integer of 0 or more and 2 or less, and f³ and f⁴ each independently represent an integer of 0 or more and 5 or less.

13. The electrophotographic apparatus according to claim 1, wherein the hole transporting material contains a compound represented by the following formula (H-1), a compound represented by the following formula (H-2), a compound represented by the following formula (H-3), a compound represented by the following formula (H-4), a compound represented by the following formula (H-5), a compound represented by the following formula (H-6), a compound represented by the following formula (H-7), a compound represented by the following formula (H-8), a compound represented by the following formula (H-9), a compound represented by the following formula (H-10), or a compound represented by the following formula (H-11).

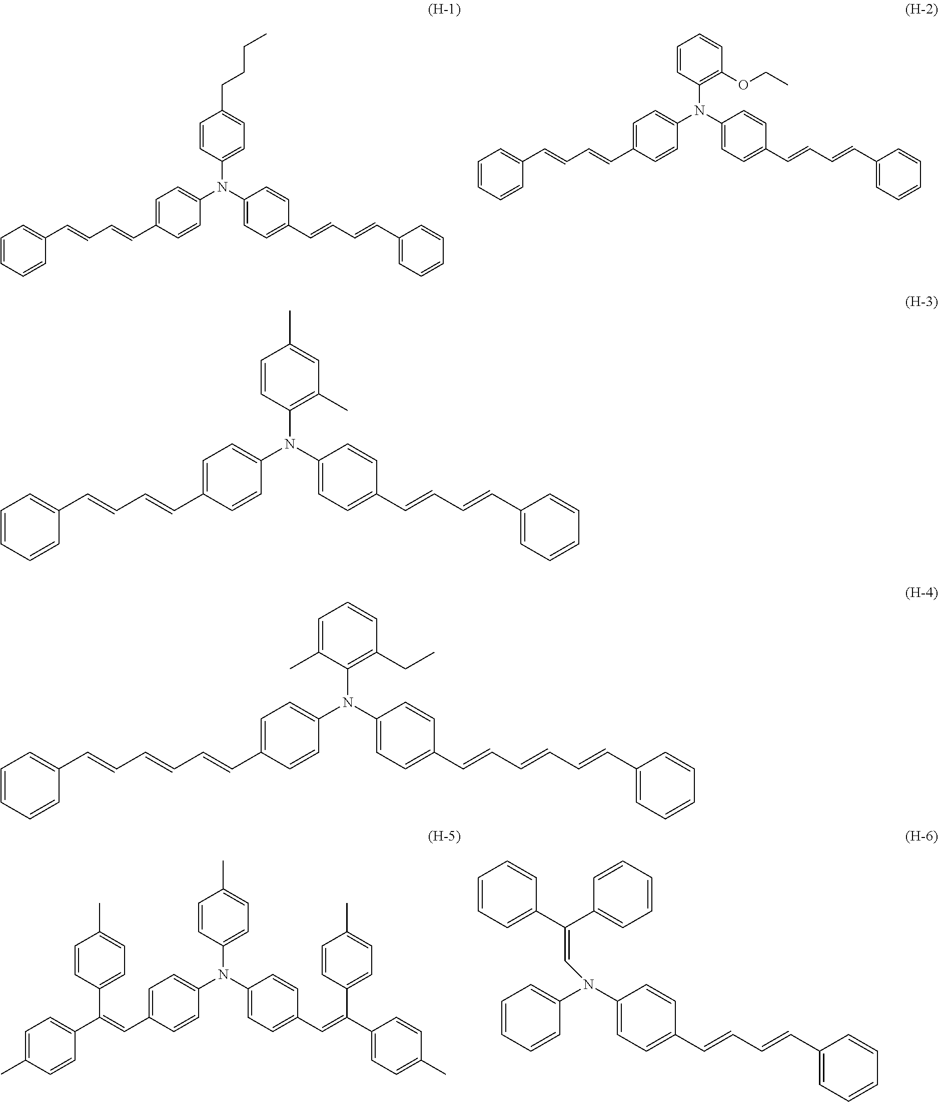

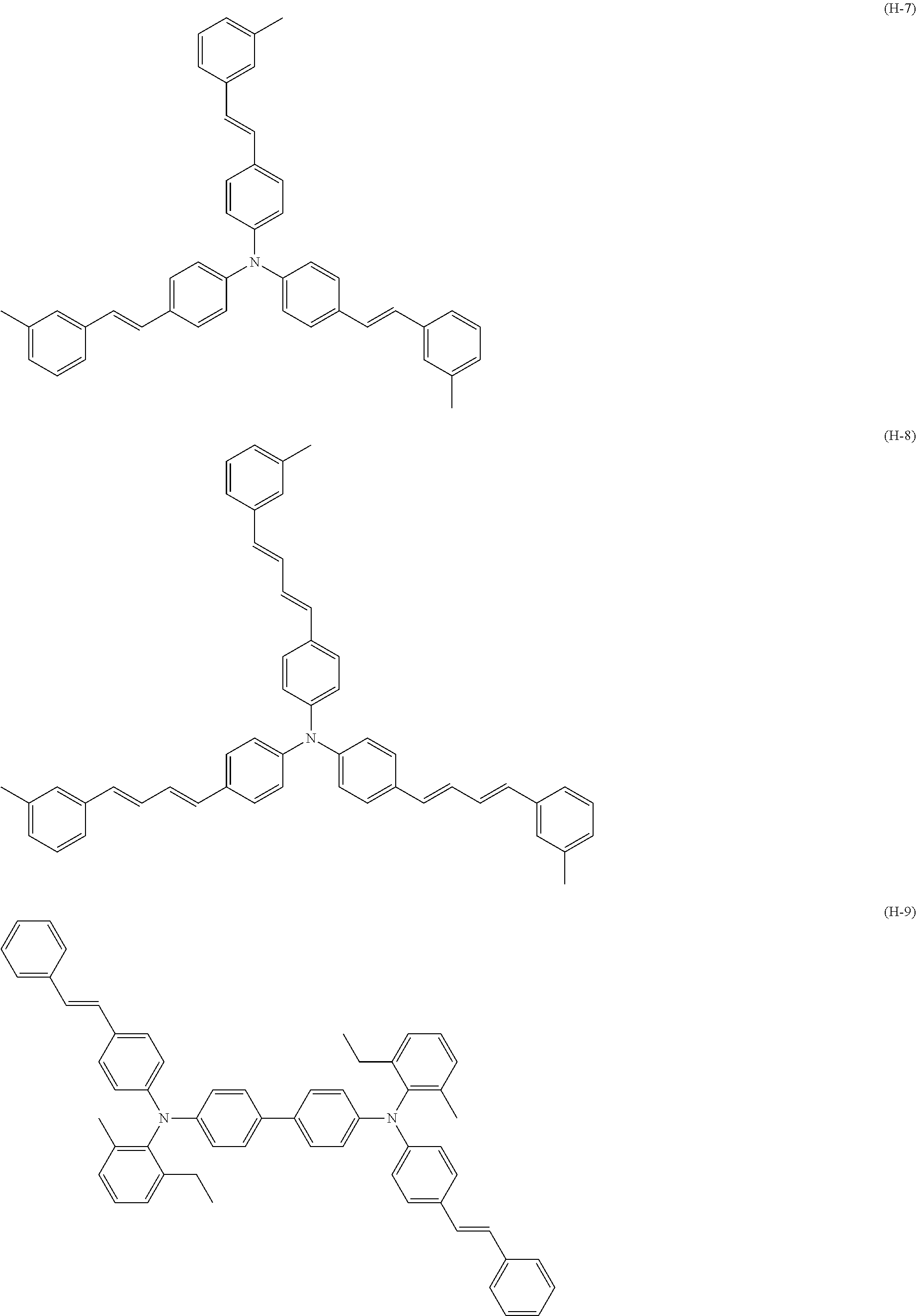 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

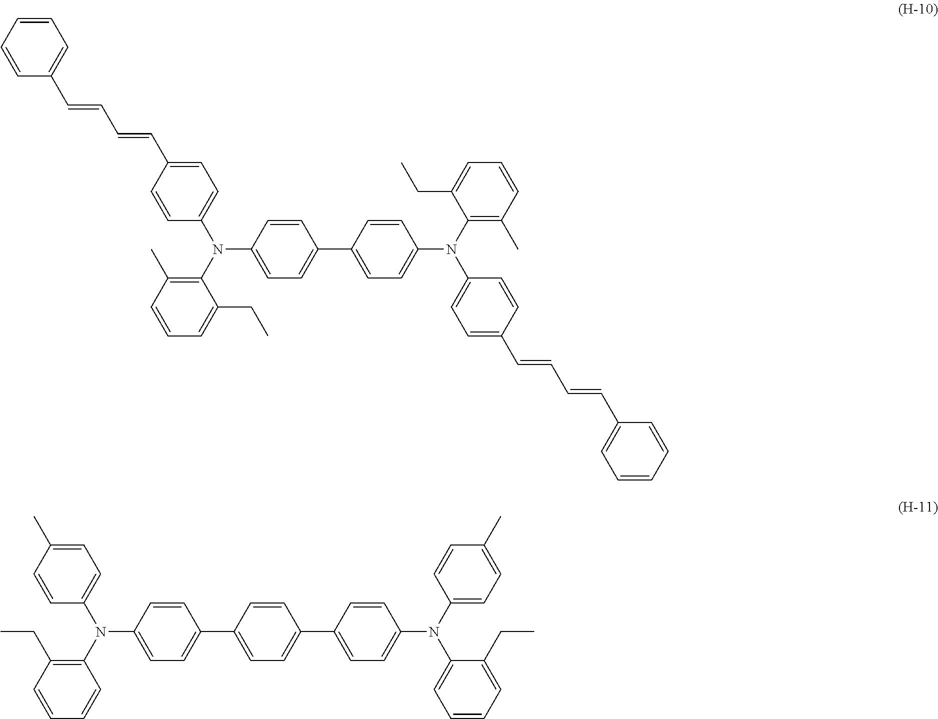 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

14. The electrophotographic apparatus according to claim 1, wherein the charge generating material contains titanyl phthalocyanine.

15. The electrophotographic apparatus according to claim 1, wherein the photosensitive layer contains a compound represented by the following formula (T-1) as an additive.

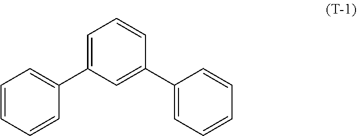 [SMILES: c1ccc(-c2cccc(-c3ccccc3)c2)cc1]

16. The electrophotographic apparatus according to claim 1, wherein the photosensitive layer has a thickness of 25 μm or more and 50 μm or less.

17. A process cartridge comprising:
an electrophotographic photosensitive member; and
a developing unit, which includes toner, and which is configured to form a toner image on a surface of the electrophotographic photosensitive member with the toner,
the process cartridge integrally supporting the electrophotographic photosensitive member and the developing unit, and being detachably attachable onto a main body of an electrophotographic apparatus,
wherein the electrophotographic photosensitive member includes a monolayer type photosensitive layer containing a charge generating material, a hole transporting material, an electron transporting material, and a binder resin,
wherein the photosensitive layer contains a polyarylate resin having a structural unit represented by the following formula (1) and a structural unit represented by the following formula (2) as the binder resin,
wherein the toner is toner containing toner particles,
wherein the toner particles each contain a toner base particle and an external additive adhering to a surface of the toner base particle, and
wherein the external additive contains at least aluminum oxide particles. [chemical structure]
